(19) United States
(12) Patent Application Publication
(10) Pub. No.: US 2009/0177836 A1
(43) Pub. Date: Jul. 9, 2009

(54) Methods and apparatuses for managing data in a computer storage system

(76) Inventor: Yasuyuki Mimatsu, Cupertino, CA (US)

Correspondence Address: MATTINGLY & MALUR, P.C., 1800 DIAGONAL ROAD, SUITE 370, ALEXANDRIA, VA, 22314, US

(21) Appl. No.: 12/007,290

(22) Filed: Jan. 9, 2008

(51) Int. Cl. G06F 13/00; G06F 12/00

(52) U.S. Cl. 711/111; 711/162; 711/112; 711/E12.001

(57) ABSTRACT

Data stored on disk drives in a storage system is automatically migrated to tape after a first predetermined time period according to a migration policy specified for the data. When the data stored to tape is to be accessed and has been deleted from the disk drives, the data is retrieved from the tape storage and stored back to the disk drives. The data is retained on the disk drives for a second predetermined time period according to a cache policy specified for the data, and then automatically deleted from the disk drives when the second predetermined time period has expired. In an alternative embodiment, when data stored to a particular disk drive has not been accessed for a predetermined time period, the particular disk drive is spun down to conserve energy. Spun down disk drives are spun up automatically when they contain results relevant to a search request.

### BACKGROUND OF THE INVENTION

1. Field of the Invention

The present invention relates generally to computer storage and information systems.

2. Description of Related Art

Modern disk storage systems are able to provide a large storage area with good performance and reliability for client computers by using magnetic disk drives to store large quantities of data which can be accessed fairly quickly. According to current trends, large enterprise storage systems require a large number of disk drives for storing massive amounts of data. For example, a digital archive system must store substantial amounts of digital data, such as email, user files, check images, and so on, for various purposes, such as meeting regulatory compliance standards, guarding against legal action, or the like. When such storage systems use only disk drives as their storage media, they have relatively expensive hardware costs because the gigabyte-per-dollar cost of disk drives is higher than many other available storage media, such as magnetic tape and optical disks.

In addition, disk drives usually consume more electric power because the platters are constantly rotating to enable retrieval of data without delay. Further, because the disk drives are constantly on, they also must be kept cool, which adds to cooling costs. These energy costs can be reduced by using other media, such as tapes or optical disks, or by spinning down (i.e., powering off or slowing down disk rotation) some or all of the disk drives. However, the other media, such a tapes and optical disks typically have lower performance, and particularly, have a long latency for accessing data stored therein. For example, tape cartridges must be loaded and the tape forwarded or rewound to an appropriate position before a read or write of data can take place. Furthermore, if a disk drive is spun down so that the platters are not rotating, then the disk drive must be spun up again (i.e., powered up or rotated at normal speed) before the data stored thereon can be accessed. Thus, if a client issues an access request to access data on such media, it can take a long time for the client to receive the data because the storage system must prepare and make the media ready to be accessed. The waiting time leaves the client idle and decreases the utilization of the client's hardware resources, such as processors, and the like.

Related art includes U.S. Pat. No. 7,035,972, to Guha et al., entitled “Method and Apparatus for Power-Efficient High-Capacity Scalable Storage System”, and U.S. Pat. No. 7,155,466, to Rodriguez et al., entitled “Policy-Based Management of a Redundant Array of Independent Nodes”, the entire disclosures of which are incorporated herein by reference.

### BRIEF SUMMARY OF THE INVENTION

The invention includes a method and apparatus for managing data in computer storage systems having a variety of storage media of different types. Embodiments of the invention enable users to know, for each piece of data, the type and characteristics of the particular storage media that stores the data, and users are able to migrate or cache the data among the various storage types by accessing metadata of the data. For example, when a user is to access data, the user is able to determine whether the particular storage type in which the data is stored requires additional time to access. Embodiments of the invention provide a method and apparatus which allow users to make the data ready to be accessed in advance, thereby enabling users to access data stored on low-performance media without a long idle time by caching the data to a higher performance media in advance of the access request, or by otherwise making the media ready for access. These and other features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated.

FIG. 1 illustrates an example of a hardware configuration in which the method and apparatus of the invention may be applied.

FIG. 2A illustrates an exemplary data structure of a data file system for storing data.

FIG. 2B illustrates an exemplary data structure of a metadata file system for storing metadata.

FIG. 2C illustrates an exemplary data structure of a metadata file system for storing metadata in the second embodiments.

FIG. 3 illustrates an exemplary data structure of a file table.

FIG. 4 illustrates an exemplary data structure of a tape table.

FIG. 5 illustrates an exemplary data structure of a default policies table showing default migration policies and default cache policies.

FIG. 6 illustrates an exemplary process flow of a storage system control program.

FIG. 7 illustrates an exemplary process flow for processing a WRITE request.

FIG. 8 illustrates an exemplary process flow for processing a READ request.

FIG. 9 illustrates an exemplary process flow for processing a DELETE request.

FIG. 10 illustrates an exemplary process flow for a background data migration process.

FIG. 11 illustrates an exemplary process flow for a background cache management process.

FIG. 12 illustrates an exemplary process flow for a procedure to access data stored on tape with a reduced idle time.

FIG. 13 illustrates an exemplary hardware configuration in which the method and apparatus of the invention may be applied for the second embodiments.

FIG. 14 illustrates an exemplary data structure of a file table of the second embodiments.

FIG. 15 illustrates an exemplary data structure of file system table of the second embodiments.

FIG. 16 illustrates an exemplary data structure of a disk drive table of the second embodiments.

FIG. 17 illustrates an exemplary data structure of default policies table of the second embodiments.

FIG. 18 illustrates an exemplary data structure of a search index.

FIG. 19 illustrates an exemplary process flow for processing of requests from clients and management server in the second embodiments.

FIG. 20 illustrates an exemplary process flow for processing a WRITE request of the second embodiments.

FIG. 21 illustrates an exemplary process flow for processing a READ request of the second embodiments.

FIG. 22 illustrates an exemplary process flow for processing a DELETE request of the second embodiments.

FIGS. 23A-23C illustrate an exemplary process flow for a background drive spin control process.

FIG. 24 illustrates an exemplary process flow for a background file deletion process.

FIG. 25 illustrates an exemplary process flow for processing a search request.

### DETAILED DESCRIPTION OF THE INVENTION

In the following detailed description of the invention, reference is made to the accompanying drawings which form a part of the disclosure, and, in which are shown by way of illustration, and not of limitation, specific embodiments by which the invention may be practiced. In the drawings, like numerals describe substantially similar components throughout the several views. Further, it should be noted that, while the detailed description provides various embodiments, as described below and as illustrated in the drawings, the present invention is not limited to the embodiments described and illustrated herein, but can extend to other embodiments, as would be known or as would become known to those skilled in the art. Additionally, the drawings, the foregoing discussion, and following description are exemplary and explanatory only, and are not intended to limit the scope of the invention or this application in any manner.

Embodiments of the invention, as will be described in greater detail below, provide an apparatus, method and computer program for a storage system that contains various different types of storage media having varying cost and performance characteristics. When some of the storage media have a long access response time, the invention provides a method for clients to know which media stores particular data, and enables clients to migrate or copy the particular data to other media in order to eliminate a long delay for accessing the data. Embodiments of the invention provide for a storage system that maintains metadata for each data piece, and this metadata mechanism can be used to implement the functionalities described above.

A part of the storage system's storage area may consist of storage media other than ordinary disk drives. For example, disk drives that are spun down or tape storage may be used in conjunction with conventional disk drives to reduce the hardware and operating costs of the storage system. The invention includes management innovations to reduce the effect of decreased performance that would otherwise result from inclusion of tape or spun down disk drives in the storage system of the invention. For instance, for each discrete data element stored in the storage system, such as a file, object, or the like, the storage system maintains metadata that includes information about the storage area in which the data is stored. For example, if the storage system has a file system interface, files of data and metadata can be associated by a rule based on naming of path and file name. On the other hand, if the storage system is a CAS (Content Addressed Storage) system, data and metadata can be handled simply as one object via an API (Application Program Interface) provided by a library installed in the clients. The present invention is applicable to both of these and other types of data storage systems.

In embodiments of the invention, clients are able to know the type of storage area by reading the metadata. Clients also can migrate or copy data by writing instructions to the metadata. When the metadata is written, the storage system migrates or copies the data associated with the metadata based on the instructions written by the client. This allows clients to cache data stored on a low-performance media, such as a tape, to high-performance media, such as a disk drive, in advance of issuing a read request for the particular data.

### First Embodiments

In the first embodiments, a storage system of the invention includes both disk drives and a tape library. Clients are able to access data stored in both disk drives and tape via a common interface, but reading the data stored on tape takes a relatively long time compared with reading data from a disk drive. To address this issue, each data has metadata which contains information about the storage media in which the data is stored. By accessing the metadata, clients can monitor and control the kind of storage media used for each data. The metadata can also contain management policies which can be specified by clients. Data can be migrated and cached between disk and tape transparently, based on the policies.

System Architecture

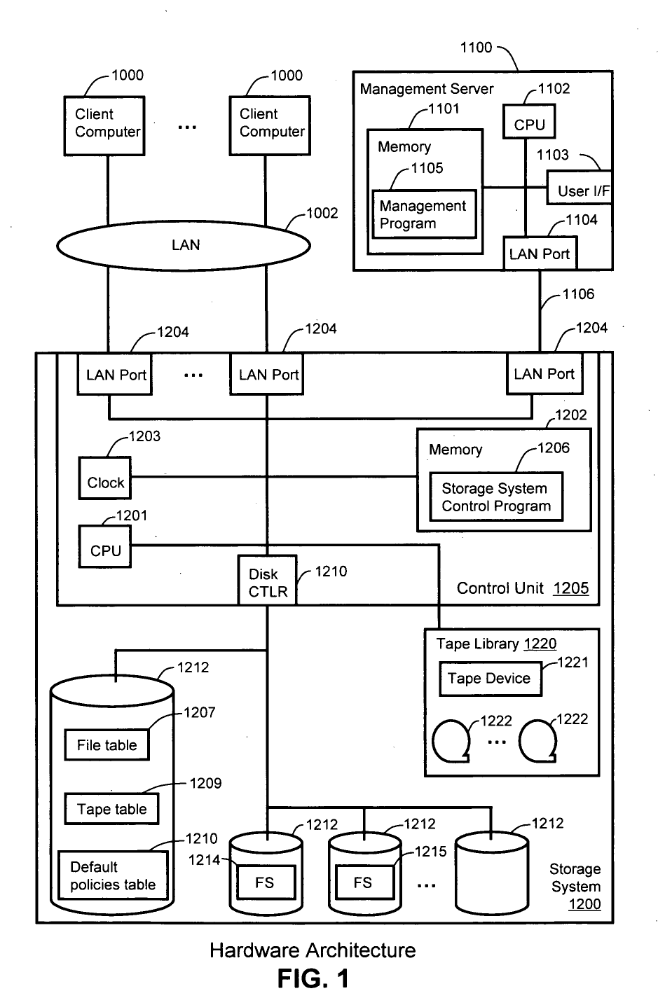

FIG. 1 illustrates an overview of an exemplary architecture of an information system in which the method and apparatus of the invention may be applied. One or more client computers 1000 are connected for communication with a storage system 1200 via a local area network (LAN) 1002. Client computers 1000 are able to access data and/or metadata stored in the storage system 1200 by issuing input/output (I/O) operations to storage system 1200 via LAN 1002. For example, in this embodiment, the storage system has a file system interface, so that the I/O requests may be issued via a standard NFS (Network File System) or CIFS (Common Internet File System) protocol, and may contain a path and file name to specify data and/or metadata which are stored as files. The I/O operations contain a command and specify a file system, a path and a file name for identifying an operation and data and/or metadata to be accessed. In this embodiment, the I/O operations may be a WRITE, a READ, or a DELETE command. On the other hand, in other embodiments, if the storage system is a CAS system, the I/O requests may contain a content address and may be issued via an API (Application Program Interface) provided by a library installed in the client computers 1000. This invention is applicable to both of these storage system types and other storage systems known in the art.

Storage system 1200 is managed by an administrator from a management server 1100. Management server 1100 has a CPU 1102 which executes a management program 1105 stored in a memory 1101. The administrator uses management program 1105 to manage storage system 1200 by communication through a user interface (I/F) 1103. Management server 1100 includes a LAN port 1104 for connecting management server 1100 for communication with storage system 1200 via a LAN cable 1106 or via LAN 1002. Thus, LAN 1106 can be unified with LAN 1002, or may be separate there from. Further, LAN 1002 may be any kind of network for enabling communication, such as Ethernet, wireless, or the like. Under the invention, the administrator typically sends two types of requests to storage system 1200: a READ request and an UPDATE request. The READ request reads a default policies table 1210 (described further below) in storage system 1200. The administrator is able to use user I/F 1103 to cause management program 1105 to set or modify the default policies table 1210, and can send an UPDATE request to update this table in the storage system with new policies.

Storage system 1200 has a control unit 1205 that includes a CPU 1201, a memory 1202 and one or more LAN ports 1204 to enable communication with client computers 1000 and management server 1100. Storage system 1200 also includes one or more data storage drives, such as disk drives 1212, in communication with control unit 1205 via a disk controller 1210, and a tape library 1220. Disk drives 1212 provide storage mediums for creating one or more logical volumes on which internal file systems 1214, 1215 may be created for storing data and metadata as files. For example, one disk drive 1212 may be shared by multiple logical volumes containing one or more file systems and/or one logical volume containing one or more file systems can span multiple disk drives 1212, such as an array group in a RAID array, or the like. However, for simplicity of discussion, each disk drive 1212 in this embodiment is illustrated as having one internal file system of the storage system 1200 stored therein. Further, each internal file system 1214, 1215 may be assigned its own file system ID which is unique in the storage system. Additionally, while storage drives 1212 are preferably hard disk drives in the illustrated embodiment, they may alternatively be solid state storage devices in some embodiments.

CPU 1201 executes a storage system control program 1206 in memory 1202, or other computer readable medium. Storage system control program 1206 not only processes I/O operations, such as READ and WRITE requests sent from clients, but also executes a background process of data migration and cache management, as is discussed further below. The timing of execution of the background process for data migration and cache management is determined by referring to a clock 1203 which provides the current time. Storage system control program 1206 also communicates with management server 1100 and processes management requests for reading and updating default policies defined by the administrator on the management server 1100.

Tape library 1220 includes a tape storage device 1221 and a plurality of tape cartridges 1222, which may be loaded in tape storage device 1221 in a juke-box type of configuration, or other such arrangement. Each tape cartridge has a tape ID which is unique in the storage system. The tape library can receive an I/O request from storage system control program 1206 when storage system control program 1206 receives an I/O request from a client computer 1000. The I/O request will normally include a tape cartridge ID and a path and name of a file to read from a tape cartridge 1222 or to write to a tape cartridge 1222. The tape library retrieves the identified tape cartridge 1222 and carries out the specified operation using the tape storage device 1221.

FIG. 1 also illustrates that one of disk drives 1212 contains several management tables, namely a file table 1207, a tape table 1209, and the default policies table 1210. The details of each of these tables are described later. Further, while the tables are illustrated as being stored in a separate disk drive 1212, they may alternatively be stored in the same disk drives 1212 as file systems 1214, 1215. Additionally, these tables will typically be loaded into memory 1202 during operation of storage system 1200 in order to reduce access latency.

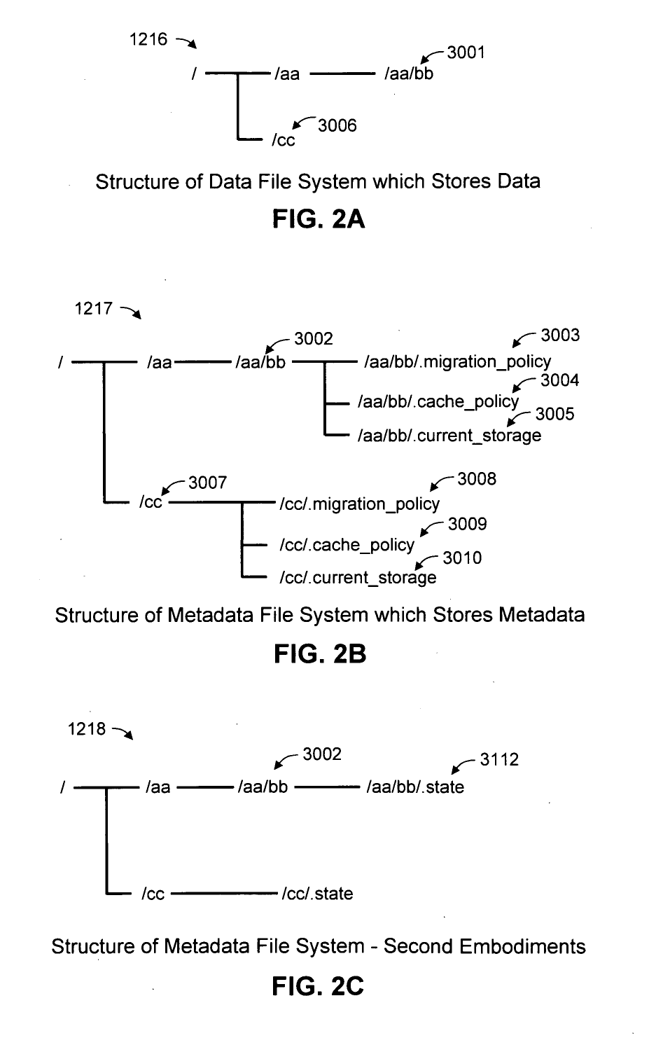

As illustrated in FIGS. 2A-2B, in the first embodiments, storage system 1200 may export two file systems for use by clients 1000, namely, a data file system 1216, which contains data files, and a metadata file system 1217, which contains metadata files. The physical capacity of the data file system 1216 may be provided through internal file systems 1214, 1215, or the like. The metadata file system 1217 may be a virtual file system for exporting metadata in management tables as files. For each data file in the data file system 1216, the metadata file system 1217 has a directory which contains one or more metadata files. However, it is not necessary to create actual files, as the metadata is contained in the file table 1207, tape table 1209 and default policies table 1210. As discussed further below, the virtual metadata file system 1217 enables clients to access the metadata information as if accessing a file, for example, by using a READ or WRITE command. In this embodiment, the name of the directory in the metadata file system 1217 is the same as the name of the data file in the data file system 1216. For example, as illustrated in FIG. 2A, a data file system 1216 is created having a first data file 3001 having a file path/name “/aa/bb”. As illustrated in FIG. 2B, in the metadata file system 1217 there is a corresponding directory 3002 named “/aa/bb” which contains metadata files of the file “/aa/bb” 3001. In the illustrated embodiment, a client sees three metadata files for first data file 3001, namely a “migration_policy” file 3003 which contains the migration policy set for the file 3001, a “cache_policy” file 3004, which contains a cache policy set for the file 3001, and a “current_storage” file 3005, which contains a storage media type in which the file 3001 is currently stored. Similarly, a second file 3006, named “/cc” in data file system 1216 has in metadata file system 1217 a corresponding directory 3007 named “/cc” that includes three metadata files for second data file 3006, namely a “migration_policy” file 3008 which contains the migration policy set for the file 3006, a “cache_policy” file 3009, which contains a cache policy set for the file 3006, and a “current_storage” file 3010, which contains a storage media type in which the file 3006 is currently stored.

Management Table and Metadata

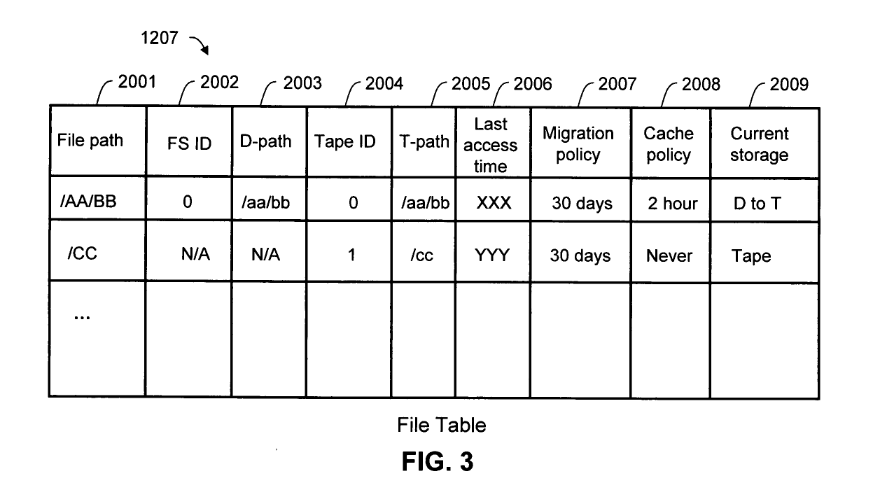

As illustrated in FIG. 3, file table 1207 contains, for each data file, a file path 2001 including a file name which is recognized by the clients; a file system ID 2002 of the file system in which the file exists when the file is stored on a disk; a D-path 2003, which is a disk path of the path and file name of the file in the file system when the file is stored on a disk; a tape ID 2004, which an identifier of a tape cartridge in which the file is stored; a T-path 2005, which is a path and file name of the file stored in the tape cartridge; a last access time of the file 2006, which was the time at which the file was last accessed by a client; a migration policy 2007 applied to the file; a cache policy 2008 which is applied to the file; and a current storage area where the file exists 2009. When a file does not exist in the disk drives 1212, the FS ID 2002 and the D-path 2003 are set to “N/A”. When a file has not yet been stored to tape, the tape ID 2004 and the T-path 2005 are set to “N/A”.

Migration policy 2007 can be set to a specified time period or can be set to “Manual”. When a time period is specified in the migration policy 2007 for a file, the file is migrated to tape at the expiration of the time period. For example, a file which exists in a disk drive 1212 and has not been copied to tape will be migrated to tape by storage system control program 1206 after the migration period elapses, as measured from the last access time. When the migration period has elapsed with no accesses to the file during that period, this indicates that the particular file is rarely accessed, and thus, does not have to be kept in the disk drives. Otherwise, if the migration policy is set to “Manual”, the storage system control program 106 does not migrate the file to tape unless a client or administrator requests migration of the file.

The cache policy 2008 can be set to a specified time period or set to “Never”. If a time period is specified for the cache policy 2008, a file which is stored on tape and which is read by a client will be copied and remain stored on a disk drive for the time period specified by the cache policy 2008. Otherwise, if the cache policy 2008 for a file is “Never”, then the storage system control program never retains the file in a disk drive after the file has been migrated to tape.

Current storage 2009 of a file can be any of the following five values: “Disk”, which means that the file exists in a disk drive only; “Tape”, which means that the file exists in tape only; “D to T”, which means the file exists in a disk drive and is currently being copied to tape; “T to D”, which means the file exists in tape and is currently being copied to a disk drive; or “D and T”, which means that the file currently exists in both a disk drive and on a tape.

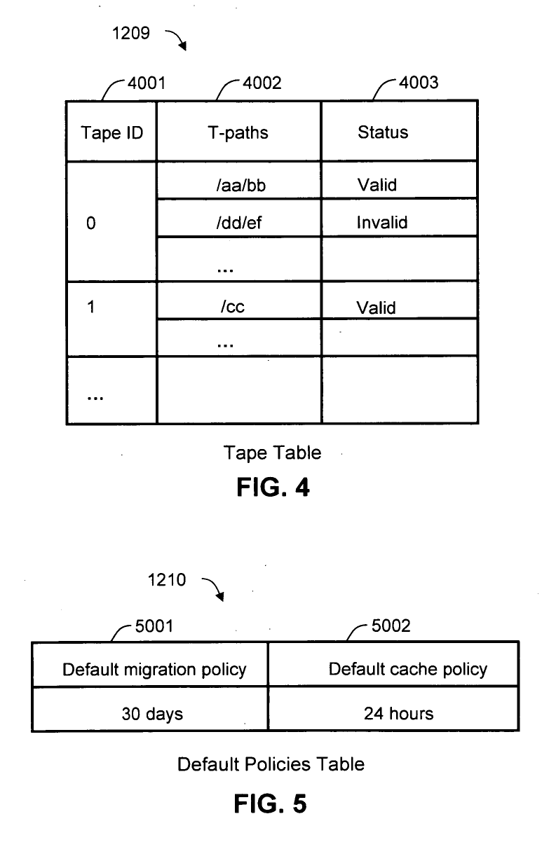

As illustrated in FIG. 4, tape table 1209 contains a tape ID 4001 for each tape cartridge. Tape table 1209 also contains, for each file stored in each tape cartridge, the T-paths 4002, which are the path and file name of each file, and a status 4003. The status 4003 of a file can be “Valid” or “Invalid”. “Valid” means that the file is exported to clients (i.e., available for access by a client). “Invalid” means the file exists on the tape but is not exported to clients (i.e., no longer available for access). For example, when a file on tape is updated or deleted by a client, storage system control program 1206 marks the file as “Invalid” in tape table 1209.

As illustrated in FIG. 5, default policies table 1210 contains a default migration policy 5001 and a default cache policy 5002. When a new file is created by a client, these default policies are typically applied to the file. However, a client or administrator may set other policies to apply to particular files, such as through the use of a WRITE command, as discussed further below. Further, as described above, default migration policy 5001 may be a specified time period or “Manual”, and the default cache policy may be a specified time period or “Never”.

Process Flow of the Storage System Control Program

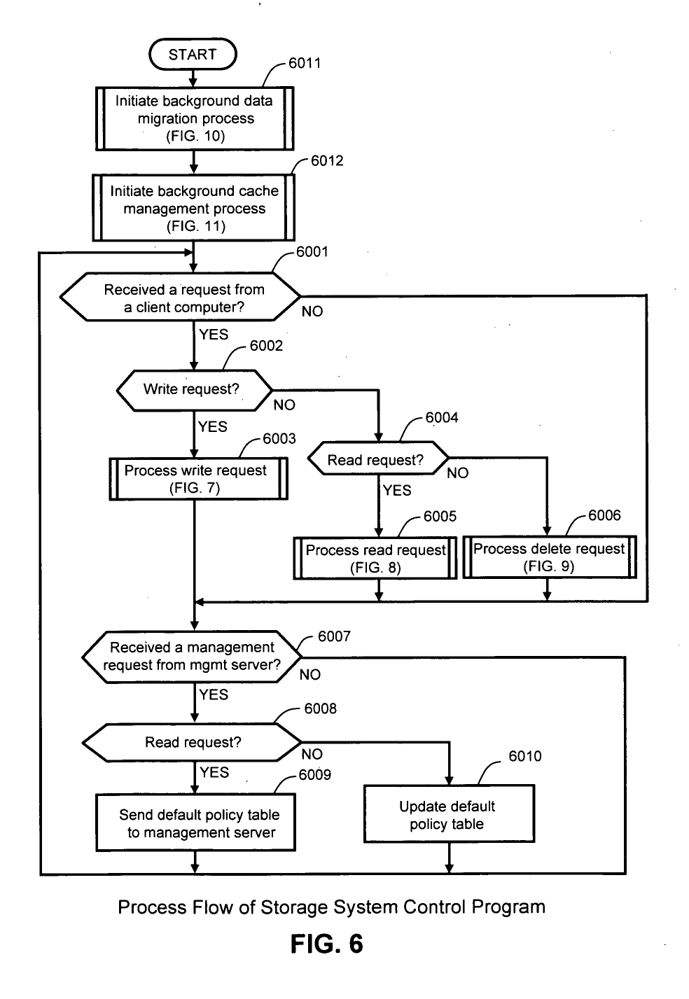

FIG. 6 illustrates an exemplary process flow of storage system control program 1206 in the first embodiments of the invention.

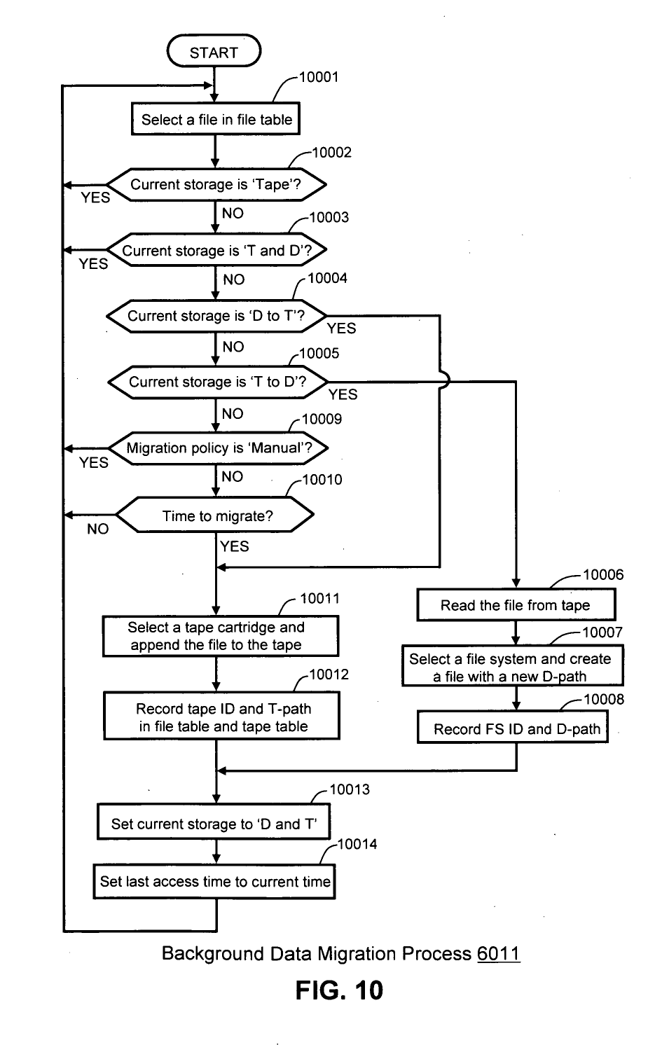

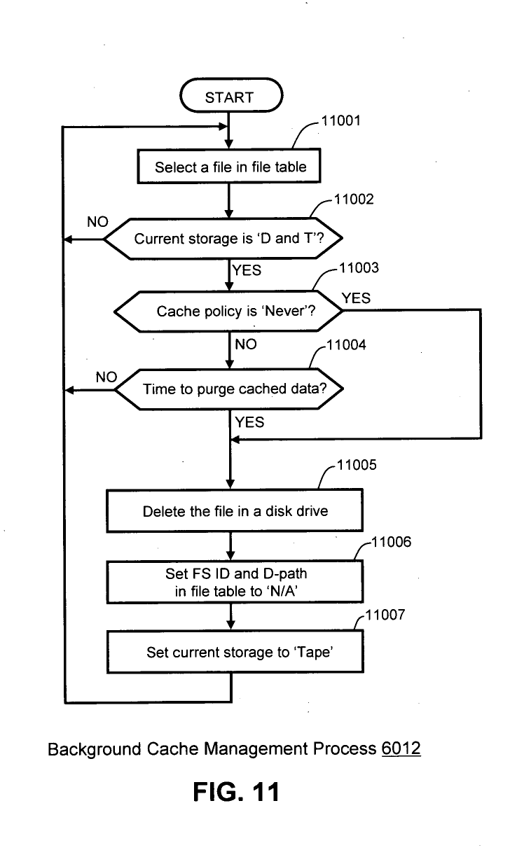

Initially, in steps 6011 and 6012, storage system control program 1206 initiates background processes for data migration and cache management. An exemplary background process to migrate data is illustrated in FIG. 10, and is described further below. An exemplary background process to manage cached data is illustrated in FIG. 11, and is described further below.

At step 6001, storage system control program 1206 processes a received request to determine if the request is from a client computer. When the storage system control program 1206 receives an I/O operation from a client computer, according to the invention, the I/O operation will normally be one of a WRITE, READ, or DELETE request, and the process goes to step 6002. On the other hand, if the received request is not from a client computer, the process skips to step 6007.

At step 6002, the process determines whether the received request is a WRITE request.

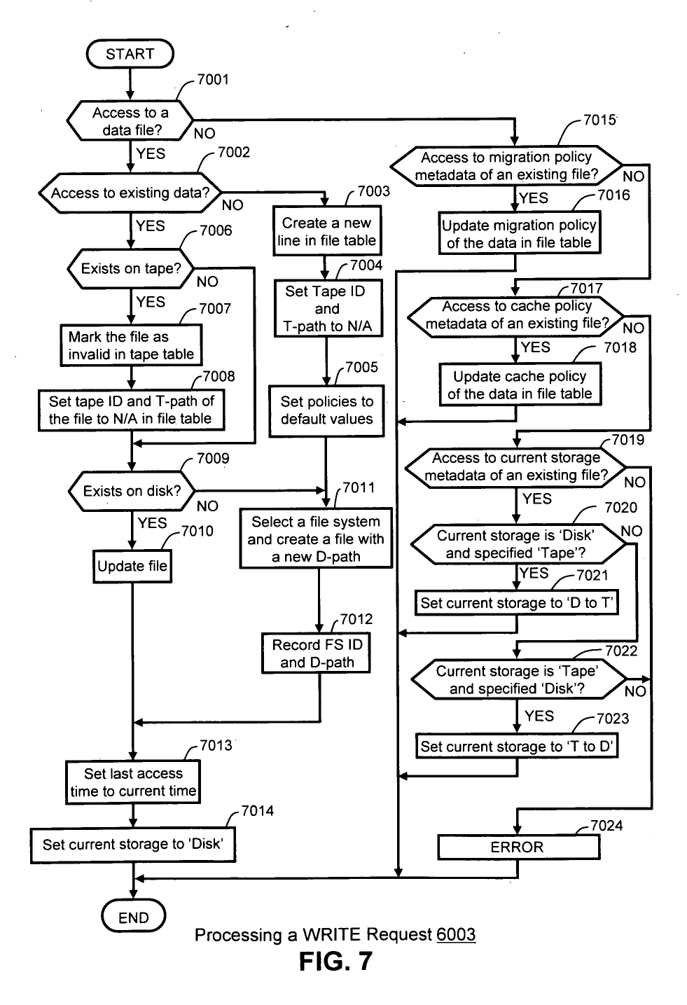

At step 6003, when the request is a write request, the request is processed according to the exemplary process flow for a WRITE request set forth in FIG. 7, and as described further below.

At step 6004, the process determines whether the received request is a READ request.

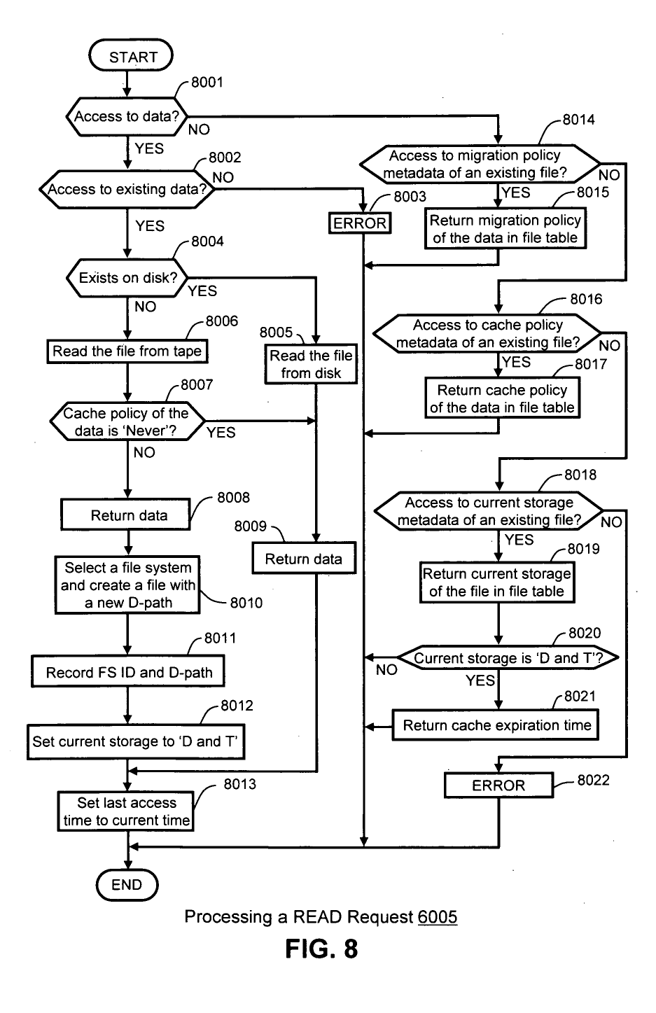

At step 6005, when the request is a READ request, the request is processed according to the exemplary process flow for a READ request set forth in FIG. 8, and as described further below.

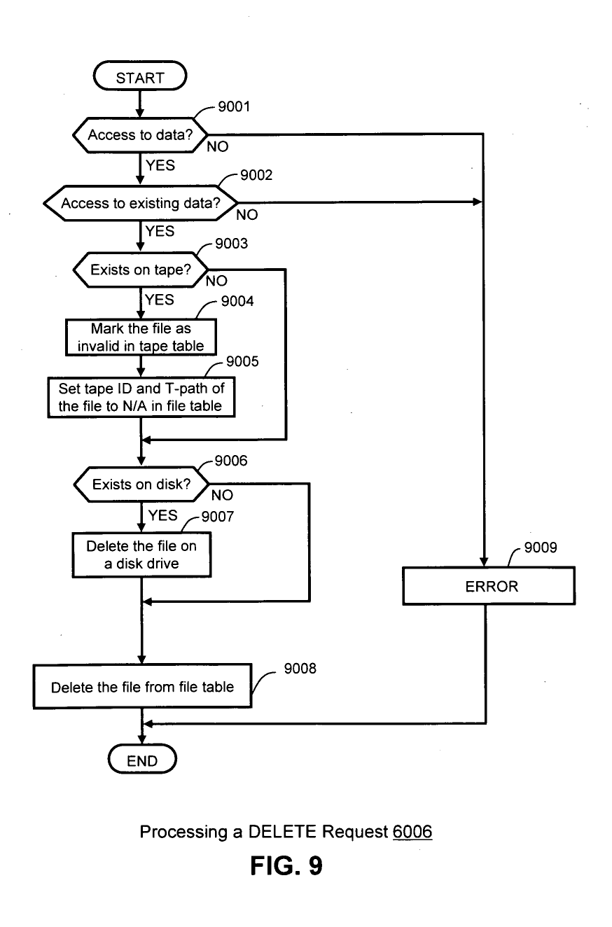

At step 6006, the request is determined to be a DELETE request, so the request is processed according to the exemplary process flow for a DELETE request set forth in FIG. 9, and as described further below.

At step 6007, the process determines whether the request was received from the management server. If the request was not received from a client or the management server, then it is not a request to be processed under the invention.

At step 6008, the process determines whether the request is a READ request.

At step 6009, when the request is a READ request, storage system control program 1206 reads the current default policies table 1210 from disk drive 1212 or memory 1202, and sends this to management server 1100 in response to the READ request.

At step 6010, when the request is an UPDATE request, the process updates the current default policy table 1210 in accordance with the new default policies set forth in the request. For example, a new time period might be specified for the default migration policy 5001 and/or the default cache policy 5002.

Process Flows of I/O Requests Sent from Clients

FIG. 7 illustrates the detailed flow of an exemplary process carried out for a WRITE request sent from a client computer (step 6003 in FIG. 6).

In step 7001, storage system control program identifies the kind of file specified in the WRITE request, i.e., a data file or metadata file. The kind of file can be identified by determining the file system specified in the request, namely data file system 1216 for a data file or metadata file system 1217 for a metadata file.

At step 7002, when the WRITE request requires access to a data file, storage system control program 1206 identifies whether or not the file already exists by searching for the specified path and file name in the file table 1207.

At step 7003, when the file does not already exist, storage system control program 1206 creates a new line in file table 1207 with the path and file name specified in the WRITE request.

At step 7004, storage system control program 1206 sets the tape ID 2004 and T-path 2005 to “N/A” in file table 1207.

At step 7005, storage system control program 1206 also sets the migration policy 2007 and cache policy 2008 in file table 1207 by copying default values from default policies table 1210.

Otherwise, if the file specified in the WRITE request already exists, then at step 7006, storage system control program 1206 also determines whether the file exists in tape, by referring to file table 1207 to see if Tape ID 2004 and T-path 2005 of the specified file in file table 1207 is not set to “N/A”.

At step 7007, when the file does currently exist in tape, storage system control program 1206 marks the corresponding entry for the file as “Invalid” in tape table 1209 because the existing file will be overwritten and will no longer be consistent with an updated copy in the disk drive. The file in tape table 1209 can be found by using the entries for Tape ID 2004 and T-path 2005 from the file table 1207.

At step 7008, storage system control program 1206 sets Tape ID 2004 and T-path 2005 for the file to “N/A” in file table 1207.

At step 7009, storage system control program 1206 determines whether the file currently exists in a disk drive by referring to file table 1207 to see if FS ID 2002 and D-path 2003 are not “N/A”.

At step 7010, when the file does currently exist on disk, storage system control program 1206 updates the file in accordance with the WRITE request.

On the other hand, at step 7011, when the file does not currently exist on disk, storage system control program 1206 selects a file system and creates a new file in the selected file system according to the WRITE request.

At step 7012, storage system control program 1206 records the file system ID of the selected file system and file path and file name of the created file as FS ID 2002 and D-path 2003 in file table 1207, respectively.

At step 7013, storage system control program 1206, by referring to clock 1203, records the current time from clock 1203 as the last access time 2006 of the created/updated file in file table 1207.

At step 7014, storage system control program 1206 sets the current storage 2009 of the file to “Disk” in file table 1207.

Returning to step 7001, when the WRITE request is targeted to a virtual metadata file instead of a data file, the storage system control program 1206 identifies which virtual metadata file is accessed by referring to the file name included in the WRITE request.

At step 7015, storage system control program 1206 determines whether the WRITE request is an access to the migration policy of an existing file.

At step 7016, storage system control program 1206 updates the migration policy 2007 of the corresponding file in file table 1207 in accordance with the new migration policy set forth in the WRITE request. The line to be updated in file table 1207 can be found by searching file path 2001 to locate the path name of the metadata file specified in the request.

At step 7017, storage system control program 1206 determines whether the WRITE request is an access to the cache policy of an existing file.

At step 7018, storage system control program 1206 updates the cache policy 2008 of the corresponding file in file table 1207 in accordance with the new cache policy set forth in the WRITE request. The line to be updated in file table 1207 can be found by searching file path 2001 to locate the path name of the metadata file specified in the request.

At step 7019, storage system control program 1206 determines whether the WRITE request is an access to a “current_storage” metadata file, which is an instruction to control the storage location of a data file.

At step 7020, storage system control program 1206 determines whether the value set in current storage 2009 is “Disk” and whether “Tape” is specified in the WRITE request.

At step 7021, when the value of current storage 2009 in file table 1207 is “Disk” and the value specified in the WRITE request is “Tape”, then storage system control program 1206 sets the value of current storage 2009 in the file table to “D to T”.

At step 7022, storage system control program 1206 determines whether the value of current storage 2009 in file table 1207 is “Tape” and specified value in the request is “Disk”.

At step 7023, when the value of current storage 2009 in file table 1207 is “Tape” and the specified value in the WRITE request is “Disk”, storage system control program 1206 sets the value of current storage 2009 in the file table 1207 to “T to D”.

By changing the value of current storage metadata in file table 1207, storage system control program 1206 notifies the background data migration process (FIG. 10) to migrate the file to a specified storage area. Otherwise, when none of the above contingencies is satisfied, the WRITE request to the metadata file is invalid and results in the return of an error at step 7024.

FIG. 8 illustrates an exemplary detailed flow of processing of a READ request sent from a client (step 6005 in FIG. 6).

At step 8001, storage system control program identifies the kind of file specified in the READ request, i.e., a data file or metadata file. The kind of file can be identified by determining the file system specified in the request, namely data file system 1216 for a data file or metadata file system 1217 for a metadata file.

At step 8002, when the READ request requires access to a data file, storage system control program 1206 identifies whether or not the data file exists by searching for the specified path and file name in the file table 1207.

At step 8003, when the file specified in the request is a data file that does not exist, storage system control program returns error.

At step 8004, when the file does exist, storage system control program 1206 determines whether the file specified in the READ request is currently is stored on disk by determining that FS-ID 2002 and D-path 2003 in file table 1207 are not “N/A”.

At step 8005, when the file specified in the READ request currently is stored on disk, storage system control program 1206 reads the specified file from disk according to FS ID 2002 and D-path 2003 in file table 1207.

Otherwise, at step 8006, storage system control program 1206 reads the specified file from tape by specifying Tape-ID 2004 and T-path 2005.

At step 8007, storage system control program 1206 determines whether the cache policy 2008 is “Never”. If the cache policy is “Never”, the file will not be cached to disk and the process goes to step 8009. Otherwise, the process goes to steps 8008-8012.

At steps 8008 and 8009, storage system control program 1206 returns the data, to the requesting client.

At step 8010, if the cache policy 2008 of the specified file is not “Never” in the file table 1207, storage system control program 1206 will cache the file for a period of time specified by the cache policy 2008 for that file. To achieve this, storage system control program 1206 selects a file system and creates a new file, in order to create on disk a cache file of the file.

At step 8011, storage system control program 1206 records the ID of the selected file system and the path and file name of the created file as FS ID 2002 and D-path 2003 in file table 1207, respectively.

At step 8012, storage system control program 1206 sets the current storage 2009 to “D and T” because the file now exists in both disk and tape.

At step 8013, storage system control program 1206 records the current time obtained from clock 1203 as the last access time 2006 of the created/updated file in file table.

Returning to step 8001, when the READ request is targeted to a virtual metadata file instead of a data file, the storage system control program 1206 identifies which virtual metadata file is accessed by referring to the file name included in the READ request.

At step 8014, storage system control program 1206 determines whether the READ request is to read the migration policy of an existing data file.

At step 8015, storage system control program 1206 returns the migration policy 2007 of the corresponding data file in file table 1207. The migration policy 2007 in file table 1207 for the corresponding data file can be found by searching file path 2001 to locate the path name of the metadata file specified in the request.

At step 8016, storage system control program 1206 determines whether the READ request is an access to the cache policy of an existing data file.

At step 8017, storage system control program 1206 returns the cache policy 2008 of the corresponding file in file table 1207. The cache policy 2008 in file table 1207 for the corresponding data file can be found by searching file path 2001 to locate the path name of the metadata file specified in the request.

At step 8018, storage system control program 1206 determines whether the READ request is an access to a “current_storage” metadata file, for determining the storage location of a data file.

At step 8019, storage system control program 1206 returns the value set in current storage 2009 in file table 1207 for the corresponding data file.

At step 8020, storage system control program 1206 determines whether the current storage 2009 value is set to “D and T”, which means the file exists in tape and is cached in a disk drive.

At step 8021, when the current storage 2009 value is set to “D and T”, storage system control program 1206 returns the corresponding cache expiration time. The cache expiration time can be calculated by adding the value of cache policy 2008 to the last access time 2006.

At step 8022, storage system control program 1206 returns an error when none of the above conditions are satisfied.

FIG. 9 illustrates an exemplary detailed flow of the processing of a DELETE request sent from client (step 6006 in FIG. 6).

At step 9001, storage system control program identifies the kind of file specified in the DELETE request, i.e., a data file or metadata file. The kind of file can be identified by determining the file system specified in the request, namely data file system 1216 for a data file or metadata file system 1217 for a metadata file.

At step 9002, when the DELETE request requires access to a data file, storage system control program 1206 identifies whether or not the file already exists by searching for the specified path and file name in the file table 1207.

At step 9003, when the file specified in the DELETE request is located in the file table 1207, storage system control program 1206 determines whether the file exists on tape by referring to tape ID 2004 and T-path 2005 to determine if the values are other than “N/A”.

At step 9004, when the file specified in the DELETE request exists in tape, then storage system control program 1206 marks the corresponding entry for the file as “Invalid” in tape table 1209 because the existing file is considered to no longer exist. The correct file entry in tape table 1209 can be found by using the entries for Tape ID and T-path from the file table 1207.

At step 9005, storage system control program 1206 sets Tape ID 2004 and T-path 2005 for the file to “N/A” in file table 1207.

At step 9006, storage system control program 1206 determines whether the file currently exists in a disk drive by referring to file table 1207 to see whether FS ID 2002 and D-path 2003 are not “N/A”.

At step 9007, when the file does currently exist on disk, storage system control program 1206 deletes the specified file from the disk drive in accordance with the DELETE request.

At step 9008, storage system control program 1206 deletes the file entry from file table 1207.

At step 9009, when the DELETE request is determined to not be for a data file in step 9001 (i.e., is targeted to a metadata file), or if the specified file cannot be located in file table 1207 in step 9002, then storage system control program 1206 returns an error message.

Background Process of Data Migration and Cache Management

FIG. 10 illustrates an exemplary process flow of the background data migration process of storage system control program 1206 (step 6011 in FIG. 6). The process repeatedly checks all files recorded in file table 1207 on a periodic basis, and migrates files based on the status of their migration policy or a client's instructions.

At step 10001, storage system control program 1206 selects a file in file table.

At step 10002, storage system control program 1206 determines whether the current storage 2006 for the file is “Tape” in file table 1207. When the current storage 2006 is “Tape”, this means that the file is currently stored only on tape, and thus, no migration of the file from disk to tape is necessary and the process returns to step 10001 to check the next file.

At step 10003, if the current storage 2006 is not “Tape”, storage system control program 1206 determines whether the current storage is “T and D”. When the current storage is “T and D”, the process goes back to step 10001 to select the next file because the current file already exists in tape and does not have to be migrated tape. The cache management process 6012, discussed below with reference to FIG. 11, manages how long the file remains stored on disk.

At step 10004, storage system control program 1206 determines whether the current storage 2006 is “D to T”. When this is the case, that means that there has been a request or instruction, such as from a client, to migrate the file from disk to tape, and the process goes to step 10008 to migrate the file from a disk drive to tape.

At step 10005, storage system control program 1206 determines whether the current storage 2006 is “T to D”. When the current storage 2006 is “T to D”, that means that there has been a request or instruction, such as from a client, to cache the file from tape to disk, and the process goes to steps 10006-10008, discussed below. On the other hand, when the current storage 2006 is not “T to D”, this means that the current storage 2006 is “Disk”, and that no client has requested that the file be migrated, and the process goes to steps 10009-10010.

At step 10006, since the current storage is “T to D”, storage system control program 1206 reads the file from tape to create a cache file in a disk drive.

At step 10007, storage system control program 1206 selects a file system and creates the file with a new D-path 2003.

At step 10008, storage system control program 1206 records the ID of the selected file system and the path and file name of the created file as FS ID 2002 and D-path 2003 in file table 1207.

At step 10009, on the other hand, when the current storage is “Disk”, storage system control program 1206 determines whether the migration policy 2007 is “Manual”. If the migration policy is “Manual” then migration is not carried out and the process returns to step 10001 to select the next file.

At step 10010, if the migration policy is not “Manual”, storage system control program 1206 checks whether the file should be migrated from a disk drive to tape based on the migration policy 2007. Storage system control program 1206 calculates the time to migrate by adding the time period recorded as the migration policy 2007 to the last access time 2006. If the sum is older than the current time then migration of the file should be carried out. Otherwise, if it is not yet time for migration according to the migration policy 2007, the process returns to step 10001 to process the next file.

At step 10011, storage system control program 1206 selects a tape cartridge and migrates the file by appending the file at the tail of the files recorded on the tape.

At step 10012, storage system control program 1206 records the tape ID of the selected cartridge and the path and file name of the appended file as Tape ID 2004 and T-path 2005, respectively, in file table 1207 and tape table 1209, and marks the status of the file in tape table 1209 to be “valid”.

At step 10013, storage system control program 1206 sets current storage 2009 for the file to “D and T”, since the file now exists on both disk and tape.

At step 10014, storage system control program 1206 sets the last access time 2006 to the current time, and the process goes back to step 10001 to process the next file in file table 1207.

FIG. 11 illustrates an exemplary process flow of the background cache management process (step 6012 in FIG. 6) of storage system control program 1206. The cache management process continually checks all files recorded in file table and purges cache files in disk drives based on their cache policy.

At step 11001, storage system control program 1206 selects a file for processing from file table 1206.

At step 11002, storage system control program 1206 determines whether the current storage 2009 for the selected file is “D and T”. When the current storage 2009 is not “D and T”, the process goes back to step 11001 to select another file because the file is not cached in a disk drive.

At step 11003, storage system control program 1206 checks whether the cache policy 2008 of the file is “Never”. When the cache policy 2008 is “Never”, then the file needs to be deleted from the disk drive, and the process skips to step 1105.

At step 11004, when a specified time period has been entered in cache policy 2008, storage system control program 1206 compares the specified time period with the time elapsed since the last access time to determine whether it is time to purge the cached data. If the cache period has not yet expired, then the process goes back to step 11001 to select the next file for processing.

At step 11005, storage system control program 1206 identifies the file to be purged by FS ID 2002 and D-path 2003 in the file table 1207, and deletes the file from the disk.

At step 11006, storage system control program 1206 sets FS ID 2002 and D-path 2003 in file table to “N/A”.

At step 11007, storage system control program 1206 sets the current storage in the file table to “Tape” because the file now exists in tape only.

Process for a Client to Read Data with Reduced Idle Time

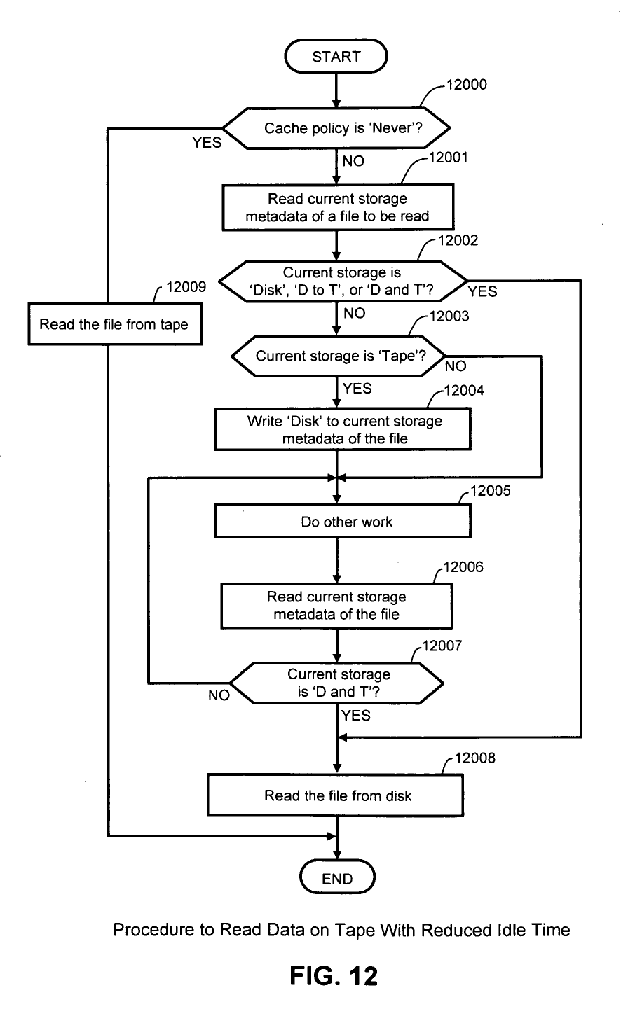

FIG. 12 illustrates an exemplary process flow carried out to enable a client to issue a READ request to read data on tape without experiencing a long idle period before receiving the data.

At step 12000, the client uses a READ request to read the “cache_policy” metadata file of the file and determine whether the cache policy 2008 for the file is “Never”. When the cache policy of the file is “Never”, then caching of the file from tape to disk is not permitted, and the process skips to step 12009 to read the file from tape.

At step 12001, the client uses a READ request to read the “current_storage” metadata file of the data file to be read.

At step 12002, the client determines whether the metadata file contains “Disk”, “D to T”, or “D and T”. When one of these values is present, then the process skips to step 12008, and the client is able to read the data file directly from disk because the file is already stored in a disk drive.

At step 12003, the client determines whether the metadata file contains “Tape”. If the “current_storage” metadata file does not contain “Tape”, then it must contain “T to D”, which means that the file is being copied from tape to disk so the client does not have to make any request to cache the file.

At step 12004, when the current storage is “Tape”, the client requests that the file be cached in a disk drive by writing “Disk” to “current_storage” metadata file, using the WRITE command discussed above with respect to FIG. 7.

At step 12005, the client can do other work until the file is cached and its “current_storage” metadata is set to “D and T” by storage system control program.

At step 12006, the client uses a READ command to determine the “current_storage” metadata of the file

At step 12007, the client verifies whether the current storage has been set to “D and T”. If not, the client waits an additional period of time, and repeats steps 12005-12007 periodically until the current storage has been set to “D and T”.

At step 12008, after the client verifies that the file is cached (current storage is “D and T”), the client issues a READ request for the file.

At step 12009, when the cache policy of the file is “Never”, the client cannot have the file cached to disk, and instead must wait while the file is read from tape.

This procedure allows a client who reads a file stored in a storage system which consists of disk drives and tapes to know whether the response time for reading the file will be long or not. This enables clients to increase processor utilization by eliminating long idle time for reading files, even when the client reads a file stored in tape.

### Second Embodiments

In the second embodiments, an information system includes a storage system having disk drives that can be selectively spun down for periods of time based on a policy in effect for the storage system in order to reduce power consumption of the storage system. Spinning a disk down essentially puts the disk in a low-power mode, such as standby, so that the disk platters are not spinning or spinning slowly, and the heads are parked, thereby reducing power consumption. However, conventionally, data stored in a disk drive which is spun down requires a long time to retrieve because the disk drive must be spun up before the data can be accessed. Thus, while clients are able to access data stored in both powered-up disk drives and powered-down disk drives via a common interface, in conventional systems it takes a much longer time to retrieve data stored in the spun-down drives.

In the system of the invention, each data element has metadata which contains information about the storage area in which the data is stored. By accessing the metadata, clients are able to monitor and control whether the drives in which the data is stored are powered up or powered down. In addition, the storage system of the invention is able to search data in the storage system based on queries received from clients. If a client searches for a piece of data and a number of different pieces of data are found, storage system control program 1206 is configured to spin up the disk drives which contain the found data without any other action from clients. The description below focuses on the differences of the second embodiments from the first embodiments.

System Architecture

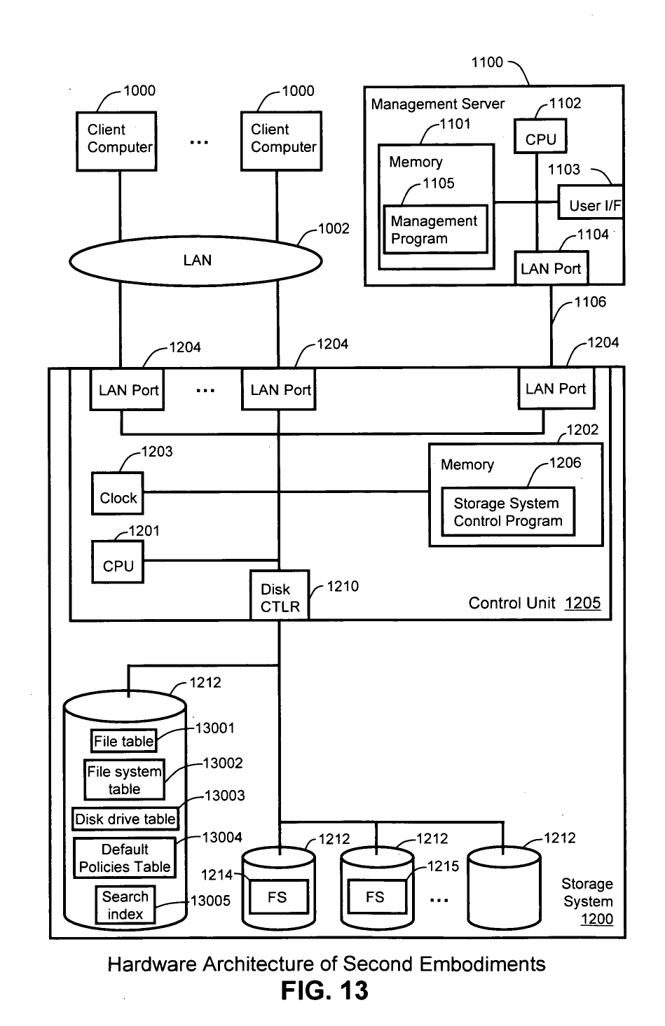

In the second embodiments, as illustrated in FIG. 13, the structure of the information system is similar to that of the first embodiments, except that the storage system does not necessarily include tape library 1220, although in some alternatives of the second embodiments, a tape library may also be included. Also, the structure and contents of the management table data structures are different. For example, as illustrated in FIG. 13, a disk drive 1212 or memory 1202 contains a file table 13001, a file system table 13002, a disk drive table 13003, a default policies table 13004, and a search index 13005. When a tape library 1220 is not included, tape table 1209 is not required. In these embodiments, as in the first, an internal file system 1214, 1215 can be contained in a logical volume that spans multiple disk drives 1212, such as an array of drives. In addition, a disk drive 1212 can be shared by multiple internal file systems created in one or more logical volumes. Data file system 1216 is similar to the first embodiments, as illustrated in FIG. 2A. However, as illustrated in FIG. 2C for the second embodiments, in a virtual metadata file system 1218, each data file has only one corresponding virtual metadata file in metadata file system 1218. The name of the virtual metadata file is “state”, and this virtual metadata file 3012 is exported to the client computers as containing the state of a file system in which the corresponding data file 3001 is stored.

Management Table and Metadata

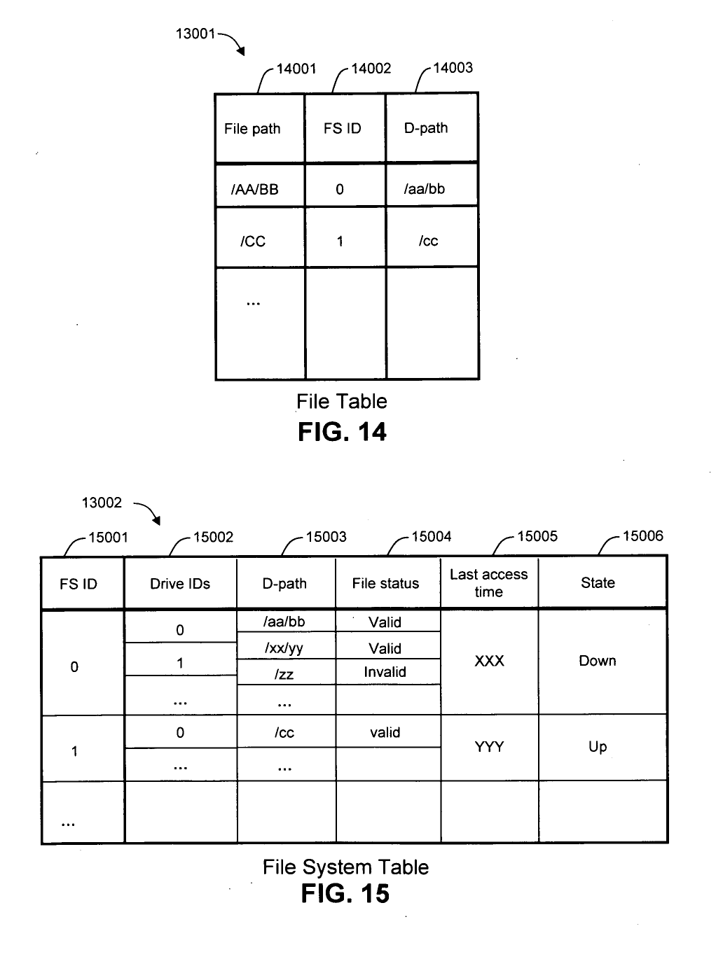

As illustrated in FIG. 14, file table 13001 contains only a file path 14001, a FS ID 14002, and a D-path 14003 in the second embodiments when a tape library is not included. These table entries have similar significance to the corresponding entries of the same name described above with reference to file table 1207 illustrated in FIG. 3 in the first embodiments.

As illustrated in FIG. 15, file system table 13002 contains, for each internal file system, an ID 15001 of the file system; Drive IDs 15002 of the one or more disk drives which compose each of the file systems; a disk path 15003 having path and file names of files which are stored in the file system; a file status 15004 of the file; a last access time 15005 of the file system, and a state 15006 of the file system.

File status 15004 can be “Valid” or “Invalid”. “Valid” means that the file is exported to clients (i.e., made accessible by the storage system for access by clients). “Invalid” means that the file exists on the file system but is not exported to clients (i.e., the clients are unable to access the file). For example, when a file is updated by a client, and that file is stored in a file system whose disk drives are spun down, a new file can be created in another file system whose disk drives are currently spun up, without having to spin up the disk drives for the file system where the file was originally located. The storage system control program 1206 then marks the original file as “Invalid” in file system table 13002.

State 15006 of a file system may be “Up”, which means all disk drives of the file system are currently spun up, “Down”, which means some or all of the disk drives of the file system are currently spun down, “Spinning up”, which means the disk drives of the file system are currently being spun up, or “Spinning down”, which means the disk drives of the file system are currently being spun down.

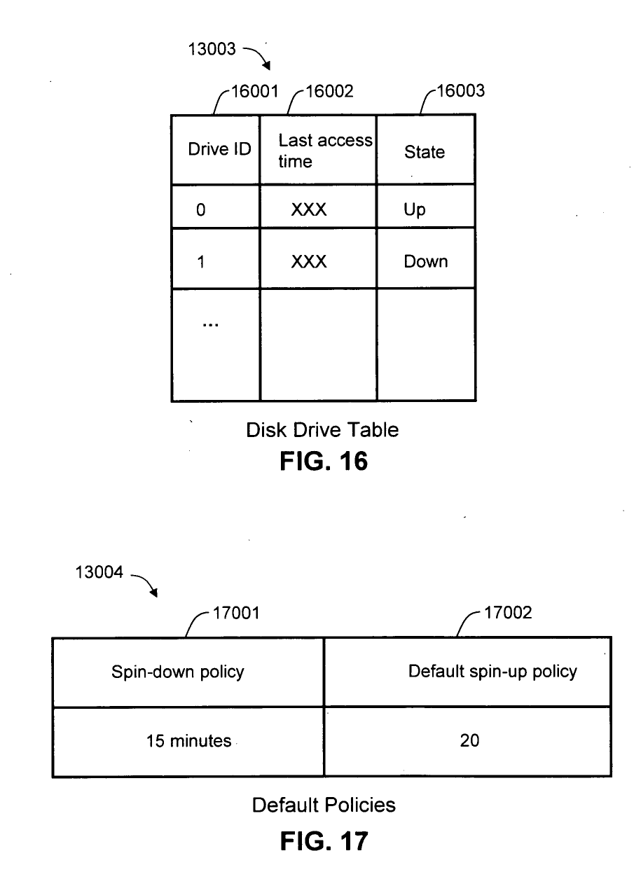

As illustrated in FIG. 16, disk drive table 13003 contains, for each disk drive which stores data, ID of the drive 16001, last access time of the drive 16002, and state of the drive 16003. Last access time 16002 is the time at which the disk was last subject to an access request. State of the disk drive 16003 can be any of the four values of state 15006 of a file system discussed above, namely, “Up”, “Down”, “Spinning Up”, or “Spinning Down”.

As illustrated in FIG. 17, default policies table 13004 contains a default spin-down policy 17001 and a default spin-up policy 17002. Default spin-down policy 17001 defines the time period that the storage system should keep a disk drive spun up after the last access to the drive. Default spin-up policy 17002 is related to a process to spin up disk drives based on search result, as discussed further below, and can be a number or “All”. If a number N is defined as the default spin-up policy 17002, storage system control program 1206 will spin up the disk drives which contain the first N files identified in search results obtained in response to a search request. If “All” is defined, storage system program will spin up all disk drives which contain files identified in a search result. The default spin-up policy is used as the default value when a spin-up policy is not specified in a search query.

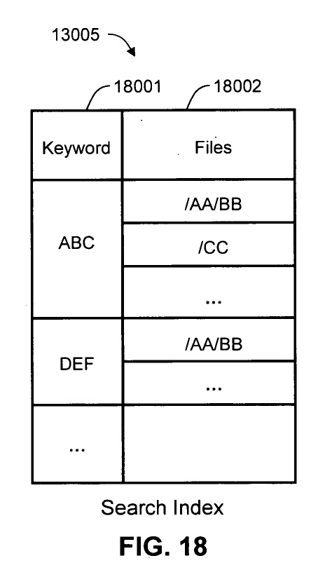

As illustrated in FIG. 18, search index 13005 contains, for each search keyword, the keyword 18001 and the path and file names of files which contain the keyword 18002. Thus, the search index 13005 serves as a searchable index containing keywords that might be searched for, and associates these keywords with specific files, so that specific files can be identified when a particular keyword is entered.

Process Flow of Storage System Control Program

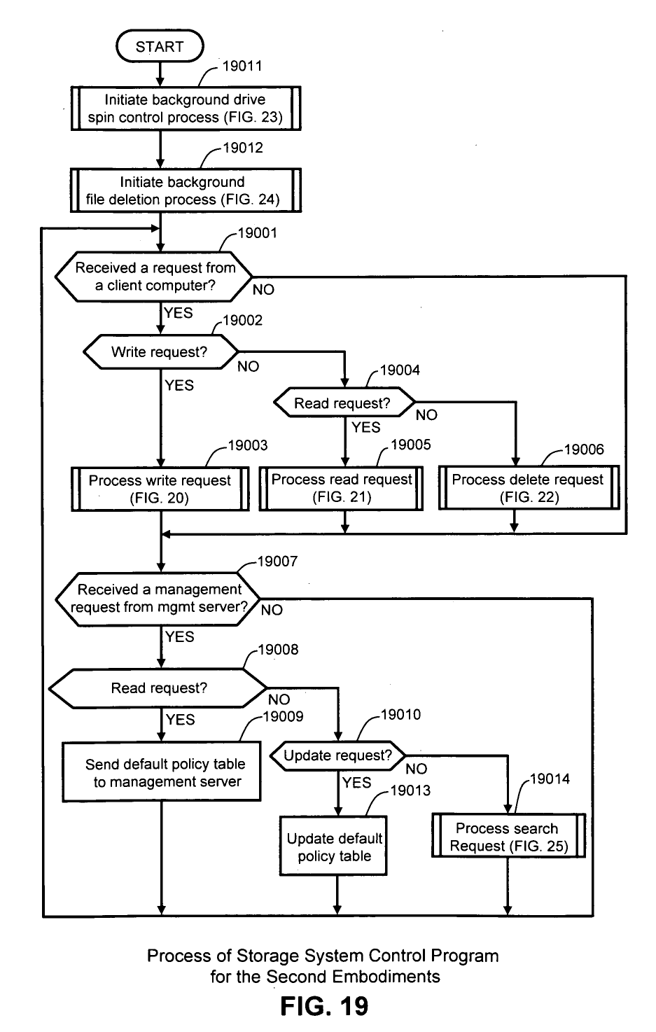

FIG. 19 illustrates an exemplary process flow of storage system control program 1206 in the second embodiments. The process is similar to that described in FIG. 6 above in the first embodiments. However, in step 19011 and 19012, storage system control program initiates background processes to control disk drive spin and to delete invalid files in file systems instead of background processes for data migration and cache management. Further, the process of the second embodiment also receives and process search queries from management server.

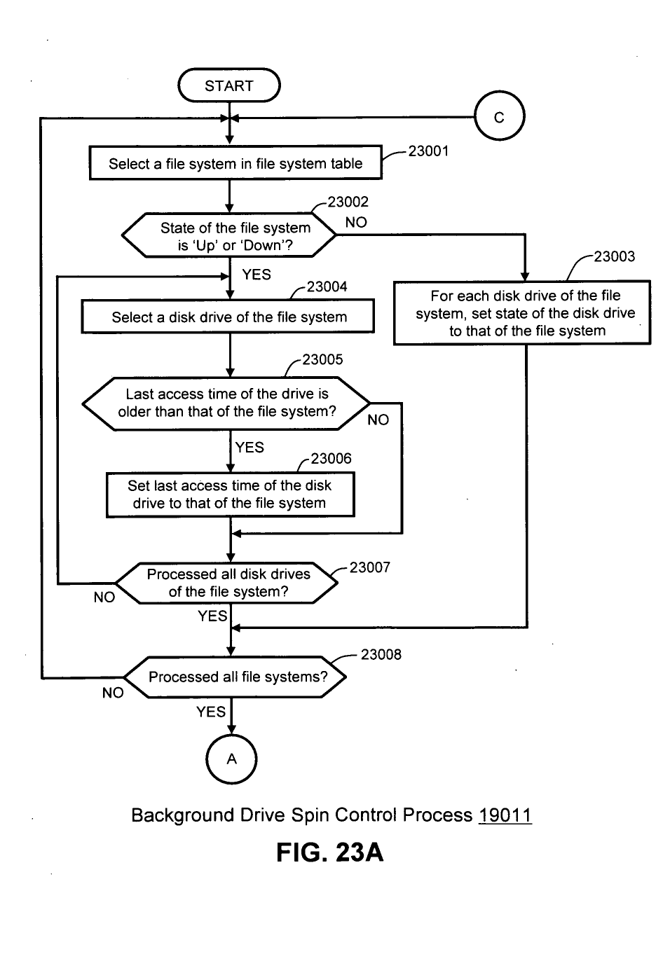

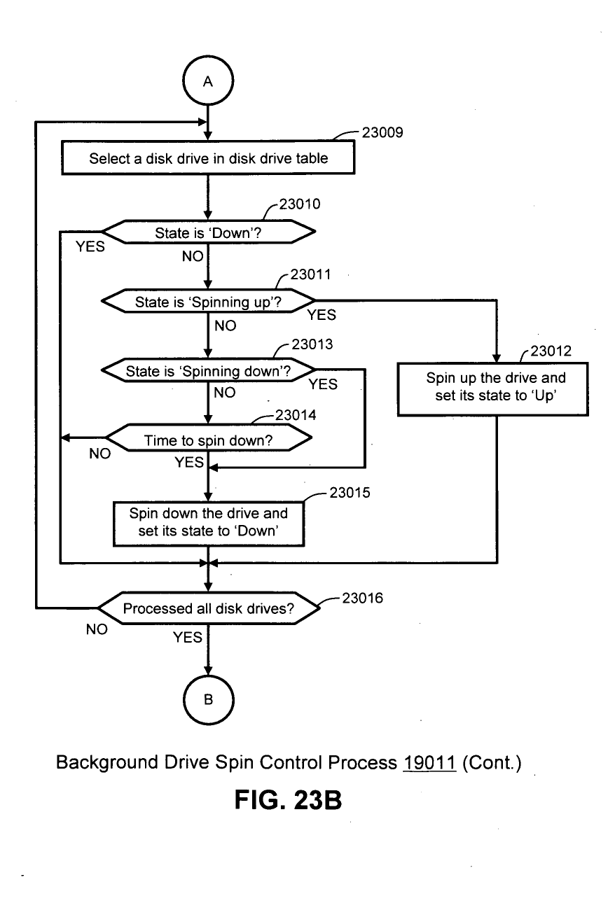

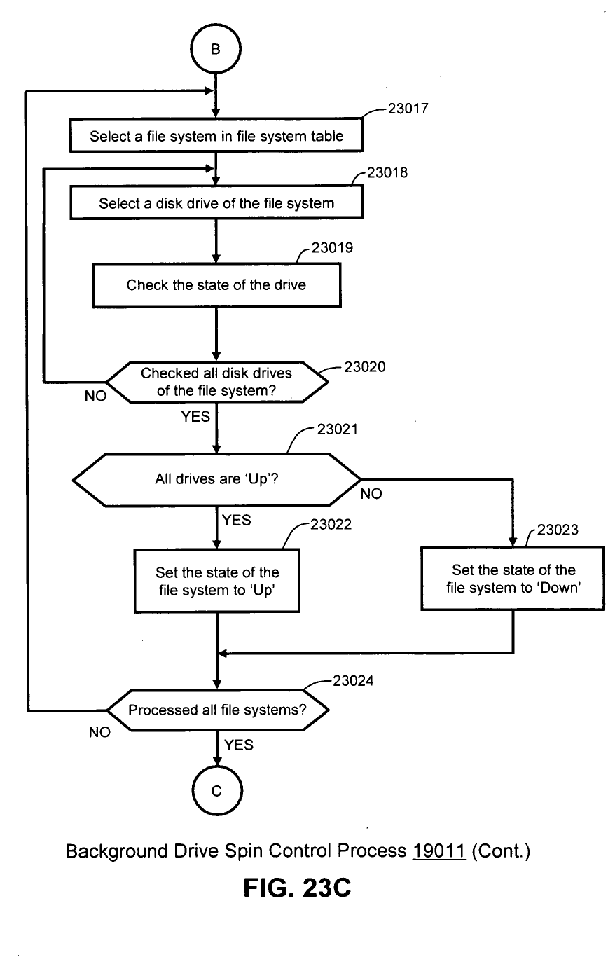

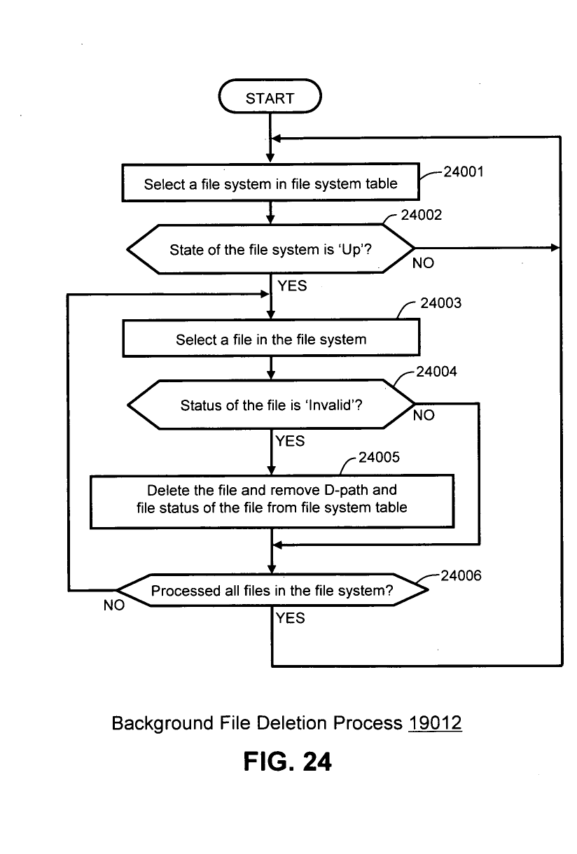

Initially, in steps 19011 and 19012, storage system control program 1206 initiates background processes for drive spin control and file deletion. An exemplary background process for drive spin control is illustrated in FIGS. 23A-23C, and is described further below. An exemplary background process to manage file deletion is illustrated in FIG. 24, and is described further below.

At step 19001, storage system control program 1206 processes received request to determine if it is a request from a client computer. When the storage system control program 1206 receives an I/O operation from a client computer, according to the invention, the I/O operation will normally be one of a WRITE, READ, or DELETE request, and the process goes to step 19002. On the other hand, if the received request is not from a client computer, the process skips to step 19007.

At step 19002, the process determines whether the received request is a WRITE request.

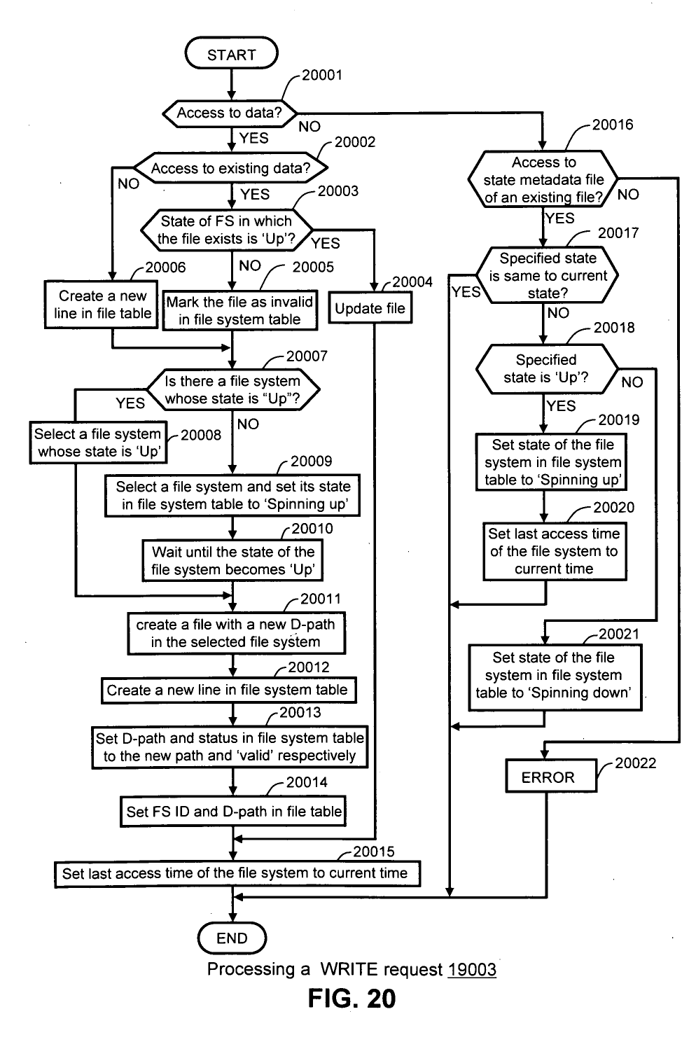

At step 19003, when the request is a write request, the request is processed according to the exemplary process flow for a WRITE request set forth in FIG. 20, and as described further below.

At step 19004, the process determines whether the received request is a READ request.

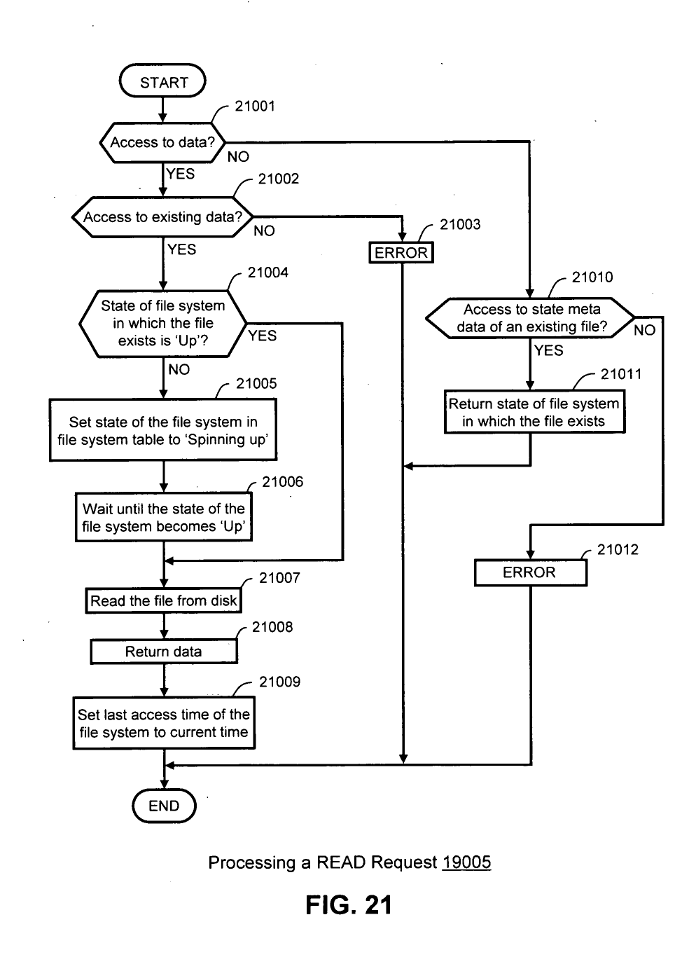

At step 19005, when the request is a READ request, the request is processed according to the exemplary process flow for a READ request set forth in FIG. 21, and as described further below.

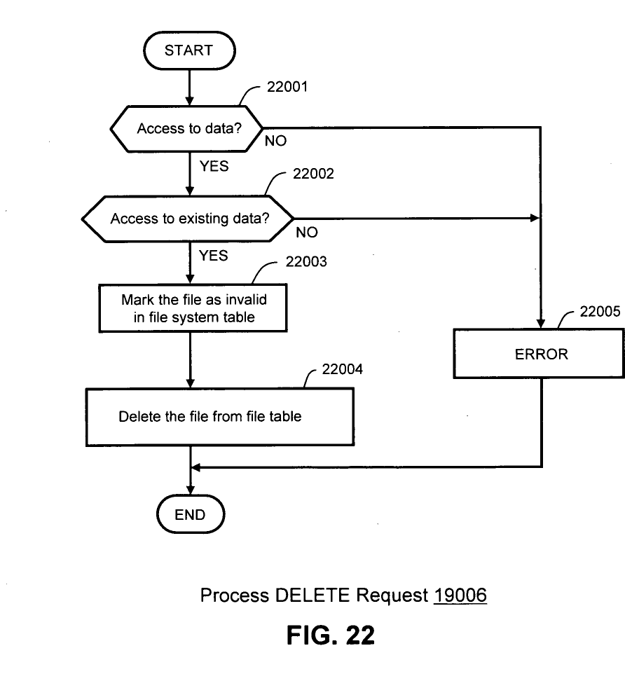

At step 19006, the request is determined to be a DELETE request, so the request is processed according to the exemplary process flow for a DELETE request set forth in FIG. 22, and as described further below.

At step 19007, the process determines whether the request was received from the management server. If the request was not received from a client or the management server, then it is not a request to be processed under the invention.

At step 19008, the process determines whether the request is a READ request.

At step 19009, when the request is a READ request from the management server, storage system control program 1206 reads the current default policies table 13004 from a disk drive 1212 or memory 1202, and sends this to management server 1100 in response to the READ request.

At step 19010, the process determines whether the request is an UPDATE request.

At step 19013, when the request is an UPDATE request, the process updates the current default policy table 13004 in accordance with new default policies set forth in the UPDATE request. For example, a new time period might be specified for the default spin-down policy 17001 and/or a new number N might be specified for the default spin-up policy 17002.

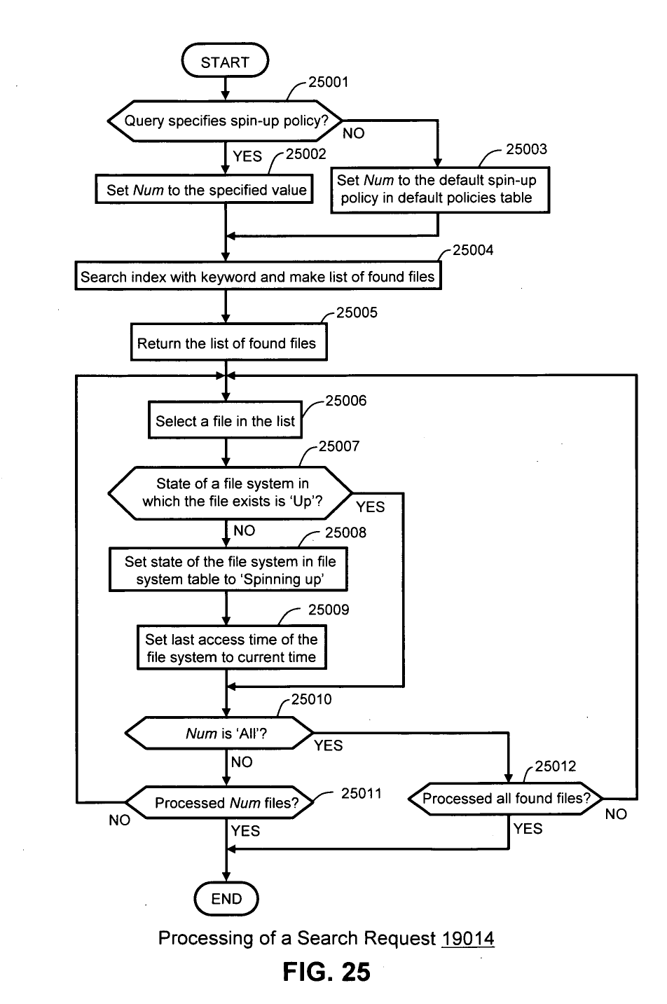

At step 19014, when the request is not an UPDATE request, the process treats the request as a search request, and processes the request in accordance with the process set forth in FIG. 25, as described below.

Processing of I/O Requests Sent from Clients

FIG. 20 illustrates an exemplary detailed flow of processing of a WRITE request sent from a client carried out in the second embodiments of the invention (step 19003 in FIG. 19).

In step 20001, storage system control program identifies the kind of file specified in the WRITE request, i.e., a data file or metadata file. The kind of file can be identified by determining the file system specified in the request, namely data file system 1216 for a data file or metadata file system 1218 for a metadata file.

At step 20002, when the WRITE request requires access to a data file, storage system control program 1206 identifies whether or not the file already exists by searching for the specified path and file name in the file table 13001.

At step 20003, when the file does already exist, storage system control program 1206 identifies the file system in which the file is stored by searching FS ID in file system table 13002 and determines whether the state 15006 of the file system is “Up”.

At step 20004, when the state of the file system in which the file currently exists is “Up”, storage system control program 1206 updates the file according to the WRITE request.

At step 20005, when the state of the file system in which the file currently exists is not “Up”, storage system control program 1206 marks the file as “Invalid” in the file system table 13002.

At step 20006, when the file specified in the WRITE command does not already exist, storage system control program 1206 creates a new line for the file in file table 13001.

At step 20007, storage system control program 1206 determines whether there is a file system in file system table 13002 whose state is “Up”.

At step 20008, when there is a file system whose current state is “Up”, storage system control program 1206 selects that file system.

At step 20009, when there is not a file system whose current state is “Up”, storage system control program 1206 selects a file system and sets its state to “Spinning Up”.

At step 20010, storage system control program 1206 waits until the state 15006 of the selected file system becomes “Up” by periodically checking file system table 13002. Background spin drive control process will process the change in the state 15006 and cause the disk drives associated with the selected file system to spin up, as described further below with respect to FIGS. 23A-23C.

At step 20011, storage system control program 1206 creates a file with a new D-path in the selected file system in accordance with the WRITE request.

At step 20012, storage system control program 1206 creates a new line in the file system table 13002

At step 20013, storage system control program 1206 sets the D-path 15003 in the file system table 13002 to the new path and file name, and sets the file status 15004 in the file system table 13002 to “valid”.

At step 20014, storage system control program 1206 sets the FS ID 14002 in file table 13001 to the selected file system ID and sets the D-path 14003 in file table 13001 to the D-path for the file.

At step 20015, storage system control program 1206 sets the last access time 15005 in file system table 13002 to the current time for the selected file system.

Returning to step 20001, when the WRITE request is targeted to a virtual metadata file instead of a data file, the storage system control program 1206 identifies which virtual metadata file is accessed by referring to the file name included in the WRITE request.

At step 20016, storage system control program 1206 determines whether the WRITE request is an access to the state metadata of an existing file.

At step 20017, storage system control program 1206 determines whether the state specified in the WRITE request is the same as the current state of the file system in which the corresponding data file is stored. If the state is the same, then no further action is required, and the process ends.

At step 20018, when the state is not the same, storage system control program 1206 determines whether the specified state is “Up”.

At step 20019, when the specified state is “Up”, storage system control program 1206 sets the state 15006 of the file system in which the corresponding file is stored to “Spinning Up” in the file system table 13002.

At step 20020, storage system control program 1206 sets the last access time 15005 for the file system to the current time.

At step 20021, when the state specified in the WRITE request is not “Up”, storage system control program 1206 sets the state 15006 of the file system in which the corresponding file is stored to “Spinning Down” and the process ends.

By changing the value of state metadata in file system table 13002, storage system control program 1206 notifies the background spin control process (FIGS. 23A-23C) to spin up or spin down the disks for a specified file system. Otherwise, when none of the above contingencies is satisfied, the WRITE request to the metadata file is invalid and results in the return of an error at step 20022.

FIG. 21 illustrates an exemplary detailed process flow of processing of a READ request sent from a client (step 19005).

At step 21001, storage system control program identifies the kind of file specified in the READ request, i.e., a data file or metadata file. The kind of file can be identified by determining the file system specified in the request, namely data file system 1216 for a data file or metadata file system 1218 for a metadata file.

At step 21002, when the READ request requires access to a data file, storage system control program 1206 identifies whether or not the data file exists by searching for the specified path and file name in the file table 13001.

At step 21003, when the file specified in the request is a data file that does not exist, storage system control program returns error.

At step 21004, when the file does exist, storage system control program 1206 determines whether the file specified in the READ request is stored in a file system in which the state 15006 is currently “Up” by referring to file system table 13002.

At step 21005, when the state of the file system is currently not “Up”, storage system control program 1206 sets the state 15006 in file system table 13002 to “Spinning Up”.

At step 21006, storage system control program 1206 waits until the state 15006 of the file system becomes “Up”, as carried out by the background procedure of FIGS. 23A-23C for disk spin control.

At step 21007, storage system control program 1206 reads the file specified in the READ request from the spun-up disk(s).

At step 21008, storage system control program 1206 returns the data to the requesting client.

At step 21009, storage system control program 1206 records the current time obtained from clock 1203 as the last access time 15005 of the corresponding file system file in file system table 13002.

Returning to step 21001, when the READ request is targeted to a virtual metadata file instead of a data file, the storage system control program 1206 identifies which virtual metadata file is accessed by referring to the file name included in the READ request.

At step 21010, storage system control program 1206 determines whether the READ request is to read the state metadata of an existing data file.

At step 21011, storage system control program 1206 returns the state metadata 15006 of the corresponding data file in file system table 13002. The state metadata 15006 in file system table 13002 for the corresponding data file can be found by searching file path 14002 in file table 13001 to determine the file system ID 14002, and then referring to file system table 13002 to determine the state of the corresponding file system.

At step 21012, storage system control program 1206 returns an error when none of the above conditions are satisfied.

FIG. 22 illustrates an exemplary detailed flow of processing of a DELETE request sent from a client (step 19006 in FIG. 19).

At step 22001, storage system control program identifies the kind of file specified in the DELETE request, i.e., a data file or metadata file. The kind of file can be identified by determining the file system specified in the request, namely data file system 1216 for a data file or metadata file system 1218 for a metadata file.

At step 22002, when the DELETE request requires access to a data file, storage system control program 1206 identifies whether or not the file already exists by searching for the specified path and file name in the file table 13001.

At step 22003, when the file specified in the DELETE request is located in the file table 13001, marks the corresponding entry for the file as “Invalid” in the file system table 13002 because the existing file is considered to no longer exist.

At step 22004, storage system control program 1206 deletes the file entry from file table 13001.

At step 22005, when the DELETE request is determined to not be for a data file in step 22001 (i.e., is targeted to a metadata file), or if the specified file cannot be located in file table 13001 in step 22002, then storage system control program 1206 returns an error message.

Background Process of Drive Spin Control and File Deletion

FIGS. 23A-23C illustrate an exemplary process flow of the background drive spin control process carried out by storage system control program 1206 in the second embodiments (step 19011 in FIG. 19). The process checks state 15006 and last access time 15005 of all file systems recorded in file system table 13002, and updates disk drive table 13003 based on this (FIG. 23A), checks all disk drives and spins the drives up or down, as specified (FIG. 23B), and updates the state of all file systems (FIG. 23C), continually.

At step 23001, as illustrated in FIG. 23A, the process selects a file system in file system table.

At step 23002, the process determines whether the state 15006 of the file system is neither “Up” nor “Down”, that is, “Spinning up” or “Spinning down”.

At step 23003, when the state of the file system “Spinning up” of “Spinning Down” the process copies, for each disk drive of the file system listed in drive ID entry 15002, the state 15006 to the state 16003 of disk drives in disk drive table 13003.

At step 23004, otherwise, when the state of the file system is “Up” or “Down”, the process selects one of the disks in the file system for checks the last access time 16002 of each disk drive of the selected file system in disk drive table 13003.

At step 23005, the process determines whether the last access time 16002 of the selected disk drive in file table 13003 is older than the last access time 15005 of the selected file system.

At step 23006, when the last access time 16002 of the selected disk drive is older than the last access time 15005 of the selected file system, the process updates the last access time 16002 of the selected disk in the disk table 13001 to be the same as the last access time 15005 of the file system.

At step 23007, the process repeats steps 23004-23006 for each disk drive in the file system, as listed in file system table 13002.

At step 23008, the process determines whether all file systems in the storage system have been processed. If not, then the process returns to step 23001. If so, then the process goes to step 23009 in FIG. 23B.

At step 23009, the process selects a disk drive in disk drive table 13003 for processing.

At step 23010, the process determines whether the state 16003 of the selected disk drive is “Down”. When the state is “Down”, the process skips to step 23016. On the other hand, if the state is not “Down”, the process goes to step 23011.

At step 23011, the process determines whether the state 16003 is “Spinning up”.

At step 23012, when the state 16003 is “Spinning Up”, the process spins up the disk drive and sets the state 16003 of the disk drive to “Up” in disk drive table 13003.

At step 23013, when the state is not “Spinning Up” in steps 23011, the process determines whether the state 16003 is “Spinning Down”. When the state is “Spinning Down”, the process skips to step 23015.

At step 23014, when the state 16003 is not “Spinning Down” then the state must be “Up”. The process determines whether it is time to spin down the disk drive by adding the time period recorded as spin down policy 17001 in default policies table 13004 to the last access time 16002 of the disk drive in disk drive table 13003. If the time is older than current time, the process goes to step 21015. On the other hand, if the time is not older than the current time, then the process skips to step 23016.

At step 23015, the process spins down the disk drive and sets the state 16003 to “Down”.

At step 23016, the process repeats steps 23009-23015 for all disk drives listed in disk drive table 13003. When all disk drives in disk drive table 13003 have been processed, the process goes to step 23017 in FIG. 23C.

At step 23017, the process selects a file system for processing from file system table 13001.

At step 23018, the process selects a disk drive for each disk drive 15002 of the file system.

At step 23019, the process checks the state 16003 of the drive in file table 13003.

At step 23020, the process determines whether the states of all the disk drives in the file system have been checked.

At step 23021, the process determines whether the state 16003 of all the disk drives in the file system is “Up”.

At step 23022, when the state of all the disk drives in the file system is “Up”, the process sets the state 15006 of the file system to “Up” in file system table 13002.

At step 23023, otherwise, if the state 16003 of any of the disk drives is “Down” in drive table 13003, the process sets the state 15006 of the file system to “Down” in file system table 13002.

At step 23024, the process repeats steps 230017-230023 for all file systems in file system table 13002, and the process then goes back to step 23001 in FIG. 23A.

FIG. 24 illustrates an exemplary process flow of the background file deletion process of storage system control program 1206 in the second embodiments (step 19012 in FIG. 19). The background file deletion process continually scans file system table 13002, and deletes each file marked as “Invalid” if the file system in which the file is stored is accessible, that is, if the state 15006 of the file system is indicated to be “Up”.

At step 24001, the process selects a file system for processing in file system table 13002.

At step 24002, the process determines whether the state 15006 of the file system is “Up”. When the state of the selected file system is not up, the process goes back to step 24001 to select the next file system.

At step 24003, when the state of the file system is “Up”, the process selects a file in the file system for processing each file recorded in file system table 13002 as be associated to the selected file system.

At step 24001, the process determines whether the file status 15004 of the file is “Invalid”. When the file status 15004 is not “Invalid”, the process skips to step 24006.

At step 24005, when the file status 15004 is “Invalid”, the process deletes the file from the file system and removes D-path 15003 and file status 15004 of the file from file system table 13002.

At step 24006, the process determines whether all files in the file system have been processed, and if not, carries out steps 24003-24005 for the next file. When all files have been processed, the process returns to step 24001 to process the next file system.

Process of Carrying Out a Search Request

FIG. 25 illustrates an exemplary process flow carried out during processing of a search request from management server (step 19012 in FIG. 19). The search request may specify the spin-up policy in addition to search keyword.

At step 25001, when storage system control program 1206 receives a search request, the program checks whether or not the spin-up policy is specified.

At step 25002, when a spin-up policy is specified with the search request, the specified value is used for this session.

At step 25003, otherwise, when a spin-up policy is not specified with the search request, the default spin-up policy in default policies table 13004 is used.

At step 25004, storage system control program 1206 refers to search index 13005 with the keyword specified in the search request. By referring to search index 13005, storage system control program 1206 compiles a list of files that include the specified keyword.

At step 25005, storage system control program 1206 returns the list of files that was compiled in step 24004.

At step 25006, for each file in the compiled list of files, storage system control program 1206 selects a file for checking the state of the file system in which the file is stored.

At step 25007, storage system control program 1206 refers to file system table 13001 and determines whether or not the state 15006 is “Up”.

At step 25008, when the state 15006 of the file system for the file is not “Up”, storage system control program 1206 sets the state 15006 to “Spinning up” so as to spin-up the disk drives of the file system which contains the file.

At step 25009, storage system control program 1206 sets the last access time 15005 of the file system to the current time.

At step 25010, storage system control program 1206 determines whether the spin-up policy is “All”.

At step 25011, when the spin-up policy is not all “All”, the steps 25006-25009 are repeated until the number of files which match the specified number of the spin-up policy have been processed. For example, if the spin-up policy is “5”, and 20 files are located by the search, then only the first 5 files are processed to spin up their associated file systems.

At step 25012, on the other hand, when the spin-up policy is “All”, then all of the files on the list are processed, so that all of the files can be immediately accessed.

Thus, the invention enables a client who reads a file stored in disk drives which can be spun down to know whether or not the expected response time for accessing a file will be long. This enables the client to increase processor utilization by eliminating long idle times, even when the client needs to access a file stored in disk drives that are spun down. In addition, it is expected that files in search results are able to be accessed with a short response time because, even when the files are stored on disk drives that are spun down, the storage system is able to spin-up the corresponding disk drives immediately without any other accesses or requests from clients.

This invention is used to provide a method and apparatus which allows clients to know the storage area in which data to be accessed exists and whether or not a long time will be required to access the data. Also, this invention is used to provide a method and apparatus which allows clients to migrate or copy data among storage areas and make the data ready to access in advance. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the above description has been made in an illustrative fashion, and not a restrictive one. Accordingly, the scope of the invention should properly be determined with reference to the appended claims, along with the full range of equivalents to which such claims are entitled.

What is claimed is:

1. A storage system comprising:
one or more disk drives;
a tape storage device; and
a control unit coupled to the plurality of disk drives and the tape storage device,
wherein data stored on the one or more disk drives is migrated to the tape storage device after a first predetermined period of time according to a migration policy,
wherein, when the data stored to the tape device is to be accessed and has been deleted from the one or more disk drives, the data is retrieved from the tape storage device and stored to the one or more disk drives,
wherein the data is retained on the one or more disk drives for a second predetermined period of time according to a cache policy, and then deleted from the one or more disk drives when the second predetermined period of time has expired.

2. The storage system according to claim 1,
wherein the data comprises a plurality of files, each file having a particular said migration policy and a particular said cache policy specified for that file, such that the migration policy and/or the cache policy is individually changeable for each file without affecting the migration policy and/or cache policy of others of the files.

3. The storage system according to claim 2,
wherein the migration policy and/or the cache policy of the particular file is changed as a result of a computer in communication with the storage system sending a WRITE request to the storage system, the WRITE request being directed to a virtual metadata file and specifying a new migration policy and/or cache policy, respectively.

4. The storage system according to claim 1,
wherein the data comprises a plurality of files, each file having a particular storage location specified for that file, such that the storage location of each file is individually changeable between the one or more disk drives and the tape storage device for each file without affecting the storage location of others of the files.

5. The storage system according to claim 4,
wherein the storage location of the particular file is changed as a result of a computer in communication with the storage system sending a WRITE request to the storage system, the WRITE request being directed to a virtual metadata file and specifying a storage location for the particular file.

6. The storage system according to claim 1,
wherein, when a computer in communication with the storage system sends a request to the storage system, the storage system determines whether the request is directed to a file or to metadata of a file, based on a file system specified in the request.

7. The storage system according to claim 1,
wherein when a computer in communication with the storage system needs to determine the migration policy, the cache policy, or a storage location of a file stored on the storage system, the computer sends a READ request to the storage system, said READ request specifying a virtual metadata file corresponding to the file,
wherein the storage system receives the READ request, identifies the corresponding file and returns information regarding the migration policy, the cache policy, or the storage location, respectively, of the corresponding file to the requesting computer.

8. The storage system according to claim 1,
wherein, when a computer in communication with the storage system knows in advance that a particular file will be accessed, the computer determines a storage location of the particular file by sending a READ request to the storage system, said READ request being directed to a virtual metadata file corresponding to the particular file,
wherein when the particular file is stored on the tape storage device, the computer sends a WRITE request to the storage system directed to the virtual metadata file corresponding to the particular file, the WRITE request specifying that the particular file be retrieved from the tape storage device and stored to the one or more disk drives so that the computer is able to access the particular file more quickly than when accessing the particular file from the tape storage device.

9. The storage system according to claim 1,
wherein, when the storage system receives a WRITE request directed to a particular file, and said particular file is stored on said tape storage device and not on said one or more disk devices, the storage system marks the particular file stored on the tape storage device as invalid, and stores a new file to said one more disk devices based upon the WRITE request to replace the particular file.

10. A storage system comprising:
a plurality of disk drives; and
a control unit coupled to the plurality of disk drives,
wherein when data stored to a particular disk drive of the plurality of disk drives has not been accessed for a predetermined period of time, the control unit causes the particular disk drive to be spun down,
wherein when the storage system receives a search request directed to locating data stored in said storage system, said storage system locates one or more files in response to the search request and automatically spins up any spun down disks drives on which at least one of the files are stored.

11. The storage system according to claim 10,
wherein the storage system automatically spins up the spun down disk drives on which the at least one file is stored with no further input or request from a computer that sent the search request.

12. The storage system according to claim 10,
wherein, when the storage system receives a WRITE request directed to a particular file, and said particular file is stored on a disk drive that is spun down, the storage system marks the particular file stored on the spun down disk drive as invalid and stores a new file based upon the WRITE request to one of said disk drives that is spun up to replace the particular file.

13. The storage system according to claim 10,
wherein when a computer in communication with the storage system needs to determine whether the disk drives on which a file is stored in the storage system are spun up or spun down, the computer sends a READ request to the storage system, said READ request specifying a virtual metadata file corresponding to the file,
wherein the storage system receives the READ request, identifies the corresponding file and returns to the requesting computer information regarding a state of the disk drives in which the file is stored.

14. The storage system according to claim 10,
wherein said storage system locates a plurality of files in response to the search request,
wherein the storage system automatically spins up disk drives storing a specified number of said plurality of files, said specified number being specified in the search request.

15. A method of operating a storage system, comprising:
storing data to one or more disk drives in the storage system;
migrating the data stored on the one or more disk drives to the tape storage device after a first predetermined period of time according to a migration policy;
retrieving the data from the tape storage device when the data stored to the tape device is to be accessed, and storing retrieved data to the one or more disk drives;
retaining the data on the one or more disk drives for a second predetermined period of time according to a cache policy; and
deleting the data from the one or more disk drives when the second predetermined period of time has expired.

16. The method according to claim 15,
wherein the data comprises a plurality of files, each file having a particular said migration policy and a particular said cache policy specified for that file, such that the migration policy and/or the cache policy is individually changeable for each file without affecting the migration policy and/or cache policy of others of the files, and further including a step of
changing the migration policy and/or the cache policy of the particular file as a result of a computer in communication with the storage system sending a WRITE request to the storage system, the WRITE request being directed to a virtual metadata file and specifying a new migration policy and/or cache policy, respectively.

17. The method according to claim 15,
wherein the data comprises a plurality of files, each file having a particular storage location specified for that file, such that the storage location of each file is individually changeable between the one or more disk drives and the tape storage device for each file without affecting the storage location of others of the files, and further including a step of
changing the storage location of the particular file as a result of a computer in communication with the storage system sending a WRITE request to the storage system, the WRITE request being directed to a virtual metadata file and specifying a storage location for the particular file.

18. The method according to claim 15, further including steps of
sending a request to the storage system by a computer in communication with the storage system; and
determining by the storage system whether the request is directed to a file or to metadata of a file based on a file system specified in the request.

19. The method according to claim 15, further including steps of
sending a READ request to the storage system by a computer in communication with the storage system, said READ request specifying a virtual metadata file corresponding to a particular file stored on the storage system, when the computer needs to determine the migration policy, the cache policy, or a storage location of the particular file;
receiving the READ request by storage system;
identifying the corresponding file by the storage system; and
returning information regarding the migration policy, the cache policy, or the storage location, respectively, of the corresponding file to the requesting computer.

20. The method according to claim 15, further including steps of
determining by a computer in communication with the storage system in advance that a particular file will be accessed;
receiving a READ request by the storage system from the computer for determining a storage location of the particular, said READ request being directed to a virtual metadata file corresponding to the particular file; and
receiving a WRITE request by the storage system from the computer when the particular file is stored on the tape storage device, the WRITE request being directed to the virtual metadata file corresponding to the particular file, the WRITE request specifying that the particular file be retrieved from the tape storage device and stored to the one or more disk drives so that the computer is able to access the particular file more quickly than when accessing the particular file from the tape storage device.
